(19) United States
(12) Patent Application Publication
(10) Pub. No.: US 2016/0212068 A1
(43) Pub. Date: Jul. 21, 2016

(54) INFORMATION PROCESSING SYSTEM AND METHOD FOR CONTROLLING INFORMATION PROCESSING SYSTEM

(71) Applicant: FUJITSU LIMITED, Kawasaki-shi (JP)

(72) Inventor: Masahiro Sato, Yokohama (JP)

(73) Assignee: FUJITSU LIMITED, Kawasaki-shi (JP)

(21) Appl. No.: 14/945,099

(22) Filed: Nov. 18, 2015

(30) Foreign Application Priority Data
Jan. 19, 2015 (JP) 2015-007711

(51) Int. Cl. H04L 12/931; H04L 12/911

(52) U.S. Cl. CPC H04L 49/70; H04L 47/746

(57) ABSTRACT

A link table stores therein information on links between devices, and a VNW table stores therein information on links on which a virtual network is set. A physical path creating unit creates a path table using the link table. A VNW path extracting unit extracts physical communication paths on which the virtual network is set from the path table using the VNW table. An associating unit associates communication between VMs with the physical communication paths using the path table, thereby creating an association table. An identifying unit identifies communication between VMs affected by a failure using the association table.

### CROSS-REFERENCE TO RELATED APPLICATION(S)

This application is based upon and claims the benefit of priority of the prior Japanese Patent Application No. 2015-007711, filed on Jan. 19, 2015, the entire contents of which are incorporated herein by reference.

### FIELD

The embodiment discussed herein is related to an information processing system and a method for controlling the information processing system.

### BACKGROUND

When a failure occurs in a network, a cloud system needs to identify a range affected by the failure and informs a user who uses the affected network. Here, a cloud system is a system designed for users to use software and data stored in a server on a computer network via the network.

FIG. 41 is a diagram for explaining identification of an affected range in a network infrastructure failure. The cloud system illustrated in FIG. 41 includes three servers #1 to #3 and four switches #1 to #4. The servers are information processing devices that process information, and the switches are devices that relay communication between the servers. The switch #4 is a backup switch, and the switches #3 and #4 are in a relation of node redundancy. A server and a switch are connected via a link, and a switch and another switch are also connected via a link. In FIG. 41, the links are indicated by the solid lines. The server #1 and the switch #1, for example, are connected via a link #1.

A virtual machine (VM) #1 operates on the server #1, a VM #2 operates on the server #2, and a VM #3 operates on the server #3. Here, a VM is a virtual information processing device that operates on a server. The VM is allocated to a tenant that uses the cloud system. A virtual network is also allocated to the tenant that uses the cloud system. In FIG. 41, a virtual local area network (VLAN) #1 served as a virtual network is allocated to a tenant X. A virtual network is indicated by a broken line.

An NW administrator 6 manages the network infrastructure. When a failure occurs in the network infrastructure, the NW administrator 6 inquires of an NW management server 91 that supports management of the network infrastructure about an affected range. The NW management server 91 includes an association table 92 in which a tenant is associated with links used by the tenant in the virtual network. When a failure occurs in a link, the NW management server 91 refers to the association table 92, thereby identifying a tenant affected by the failure. When a failure occurs in the link #4 in FIG. 41, the NW management server 91 refers to the association table 92, thereby identifying the tenant X affected by the failure.

There has been developed a technology for identifying an affected range by: acquiring management information from a management device that manages a network and servers, concentrating and storing the information for each piece of resource information in a resource information database, and searching the resource information database when a failure occurs.

There has also been developed a technology for identifying a range affected by a failure in a virtual environment by: acquiring, from each communication device, association data of a transmission destination address and a port on a group to which a virtual machine belongs, and extracting a transmission destination address relating to a communication device and a port from the association data.

Patent Literature 1: Japanese Laid-open Patent Publication No. 2012-169956

Patent Literature 2: Japanese Laid-open Patent Publication No. 2014-207594

While the conventional technology for identifying an affected tenant by referring to the association table 92 can identify a tenant affected by a failure, it fails to determine which communication between VMs allocated to the tenant is affected. FIG. 42 is a diagram for explaining the problem in identification of an affected range. Let us assume a case where communication is performed between the VMs #1 and #2, the VMs #1 and #3, and the VMs #2 and #3 in FIG. 42. When a failure occurs in the link #4, the communication between the VMs #1 and #2 and between the VMs #2 and #3 is affected by the failure. By contrast, the communication between the VMs #1 and #3 is not affected by the failure.

### SUMMARY

According to an aspect of an embodiment, an information processing system includes a switch device a plurality of information processing devices connected via the switch device and a management device that controls the switch device and the information processing devices, wherein the management device includes physical communication path information generating unit that generates physical communication path information served as communication path information between the information processing devices connected via the switch device, a virtual communication path information extracting unit that extracts virtual communication path information served as communication path information between virtual machines executed by the respective information processing devices, a path correspondence relation generating unit that extracts the physical communication path information corresponding to the extracted virtual communication path information out of the generated physical communication path information and associates the physical communication path information with the virtual communication path information, a path association information extracting unit that extracts passage links on which a virtual network is set from link information on the switch device and link information on the information processing devices included in the virtual communication path information and deletes physical communication path information corresponding to a physical communication path passing through a passage link other than the extracted passage links on which the virtual network is set from the physical communication path information extracted by the path correspondence relation generating unit, thereby extracting path association information indicative of a correspondence relation among the virtual communication path information, the physical communication path information, and the passage links on which the virtual network is set and a failure identifying unit that identifies the virtual communication path information including a passage link on which a failure occurs on the basis of the extracted path association information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an information processing system according to an embodiment of the present invention;

FIG. 2 is a diagram of a functional configuration of an influence analyzing device;

FIG. 3 is an example diagram of a link table;

FIG. 4 is an example diagram of a VM table;

FIG. 5 is an example diagram of a VNW table;

FIG. 6 is an example diagram of a path table;

FIG. 7 is an example diagram of an association table;

FIG. 8 is a diagram of a functional diagram of an association information creating unit;

FIG. 9 is an example diagram of creation of the path table using the link table;

FIG. 10 is an example diagram of creation of passage links;

FIG. 11 is an example diagram of extraction of communication between VMs;

FIG. 12 is an example diagram of extraction of communication between servers;

FIG. 13 is an example diagram of extraction of physical communication paths on a virtual network;

FIG. 14 is a first example diagram of extraction of a backup path;

FIG. 15 is a second example diagram of extraction of the backup path;

FIG. 16 is an example diagram of association of the communication between VMs with the physical communication paths;

FIG. 17 is a first example diagram of identification of an affected range in a network infrastructure failure;

FIG. 18 is a second example diagram of identification of the affected range in the network infrastructure failure;

FIG. 19 is a flowchart of association of the communication between VMs with the physical communication paths;

FIG. 20 is a flowchart of processing performed in response to notification of configuration information on a virtual system;

FIG. 21 is a flowchart of processing performed in response to notification of configuration information on a physical system;

FIG. 22 is a flowchart of processing for identifying a failure-affected range;

FIG. 23 is a diagram of a physical configuration of an information processing system used as an example;

FIG. 24 is a diagram of the path table created from link information on the target system illustrated in FIG. 23;

FIG. 25 is a diagram of physical infrastructure configuration information on the target system illustrated in FIG. 23;

FIG. 26 is an example diagram of extraction of communication between servers when VMs are created;

FIG. 27 is an example diagram of VM configuration information and VNW configuration information received by a configuration information receiving unit;

FIG. 28 is an example diagram of extraction of physical communication paths on which a virtual network is set;

FIG. 29 is an example diagram of extraction of a backup path;

FIG. 30 is an example diagram of creation of the association table;

FIG. 31 is an example diagram of update of the path table when a server is added;

FIG. 32 is an example diagram of the physical infrastructure configuration information transmitted from an NW management server and a cloud management server;

FIG. 33 is an example diagram of extraction of communication between servers when a VM is added;

FIG. 34 is an example diagram of the VM configuration information and the VNW configuration information received by the configuration information receiving unit;

FIG. 35 is an example diagram of update of the path table when the VM is added;

FIG. 36 is an example diagram of extraction of a backup path when the VM is added;

FIG. 37 is an example diagram of update of the association table when the VM is added;

FIG. 38 is an example diagram of extraction of a physical communication path affected when a failure occurs;

FIG. 39 is an example diagram of identification of an affected range when the failure occurs;

FIG. 40 is a diagram of a hardware configuration of a computer that executes a control program according to the embodiment;

FIG. 41 is a diagram for explaining identification of an affected range in a network infrastructure failure; and

FIG. 42 is a diagram for explaining a problem in identification of the affected range.

### DESCRIPTION OF EMBODIMENT(S)

Preferred embodiments of the present invention will be explained with reference to accompanying drawings. The embodiments are not intended to limit the disclosed technology.

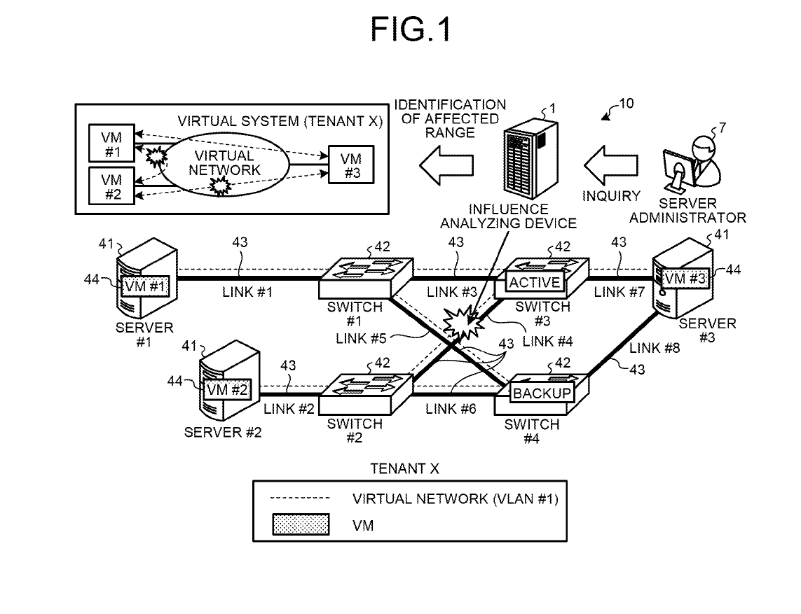

An information processing system according to an embodiment of the present invention will be described. FIG. 1 is a diagram for explaining the information processing system according to the embodiment. As illustrated in FIG. 1, an information processing system 10 according to the embodiment includes an influence analyzing device 1, three servers 41, and four switches 42. The three servers 41 are represented by servers #1 to #3, and the four switches 42 are represented by switches #1 to #4. The switch #4 is a backup switch 42, and the switches #3 and #4 are in a relation of node redundancy. A server 41 and a switch 42 are connected via a link 43, and a switch 42 and another switch 42 are also connected via a link 43. In FIG. 1, eight links 43 are represented by links #1 to #8 and indicated by the respective solid lines. The server #1 and the switch #1, for example, are connected via the link #1.

The server 41 is an information processing device that processes information. The switch 42 is a device that relays communication between the servers 41. While the information processing system 10 in FIG. 1 includes the three servers 41, the four switches 42, and the eight links 43, it may include a desired number of servers 41, switches 42, and links 43.

A VM #1 operates on the server #1, a VM #2 operates on the server #2, and a VM #3 operates on the server #3. The VMs are allocated to a tenant that uses the information processing system 10. A virtual network is also allocated to the tenant that uses the information processing system 10. In FIG. 1, a VLAN #1 is allocated to a tenant X. The virtual network is indicated by the broken line. In FIG. 1, one VM 44 is allocated to one server 41, and one virtual network is allocated to one tenant. Alternatively, a plurality of VMs 44 may be allocated to one server 41, and a plurality of virtual networks may be allocated to one tenant.

The influence analyzing device 1 identifies communication between VMs affected when a failure occurs in the network. When a failure occurs in the network infrastructure, for example, a server administrator 7 who manages the servers 41 inquires of the influence analyzing device 1 about an affected range. The influence analyzing device 1 identifies the affected communication between VMs and displays the result of identification on a display device used by the server administrator 7. When a failure occurs in the link #4 in FIG. 1, the influence analyzing device 1 identifies communication between the VMs #1 and #2 and communication between the VMs #2 and #3 as the affected communication between VMs.

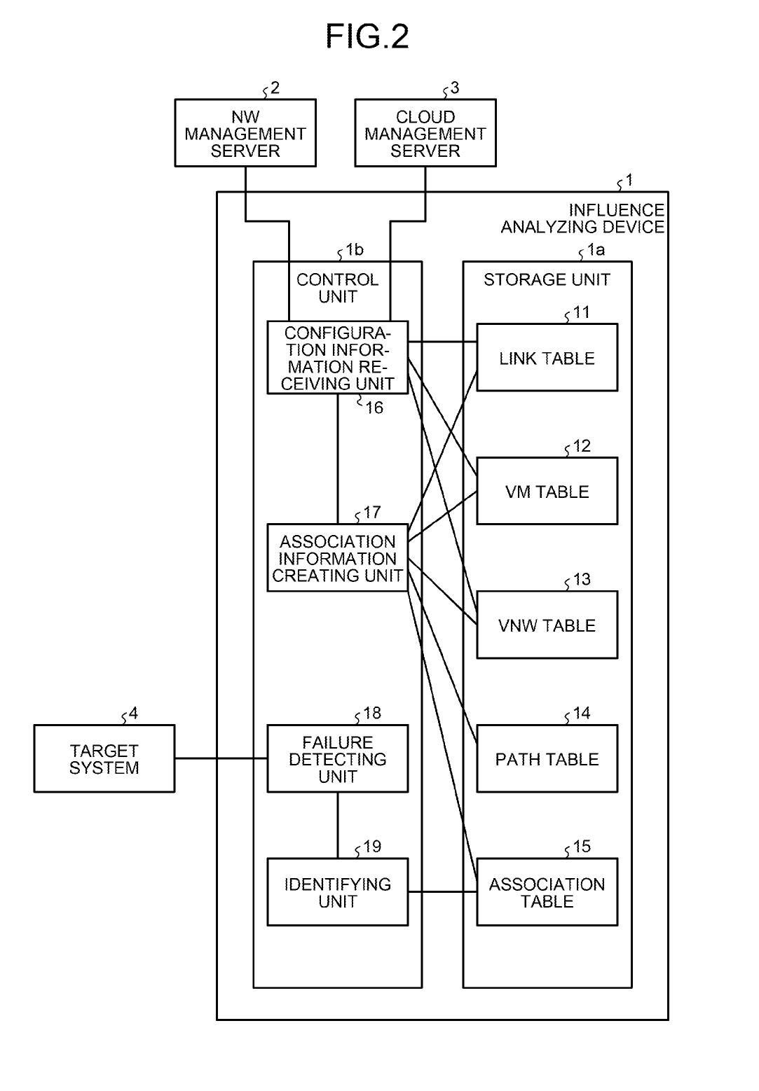

The influence analyzing device 1 will be described. FIG. 2 is a diagram of a functional configuration of the influence analyzing device 1. As illustrated in FIG. 2, the influence analyzing device 1 includes a storage unit 1a and a control unit 1b. The storage unit 1a stores therein data used to analyze influence of a failure. The control unit 1b controls an analysis of influence of a failure using the data stored in the storage unit 1a. The storage unit 1a stores therein a link table 11, a VM table 12, a VNW table 13, a path table 14, and an association table 15. The control unit 1b includes a configuration information receiving unit 16, an association information creating unit 17, a failure detecting unit 18, and an identifying unit 19.

The configuration information receiving unit 16 receives information on a network from a NW management server 2 that manages information on the network, and registers the received information in the link table 11 and the VNW table 13. The configuration information receiving unit 16 also receives information on the VMs 44 from a cloud management server 3 that manages information on the servers 41 and information on a virtual system, and registers the received information in the VM table 12. The virtual system is established on a physical system and includes the VMs 44 and the virtual network.

When the network configuration is changed, the configuration information receiving unit 16 receives notification of configuration information for notifying the influence analyzing device 1 of the change in the network configuration from the NW management server 2. When a server 41 is added or removed, the configuration information receiving unit 16 receives notification of configuration information for notifying the influence analyzing device 1 of addition or removal of the server 41 from the cloud management server 3. When a VM 44 is added or removed, the configuration information receiving unit 16 receives notification of configuration information for notifying the influence analyzing device 1 of addition or removal of the VM 44 from the cloud management server 3.

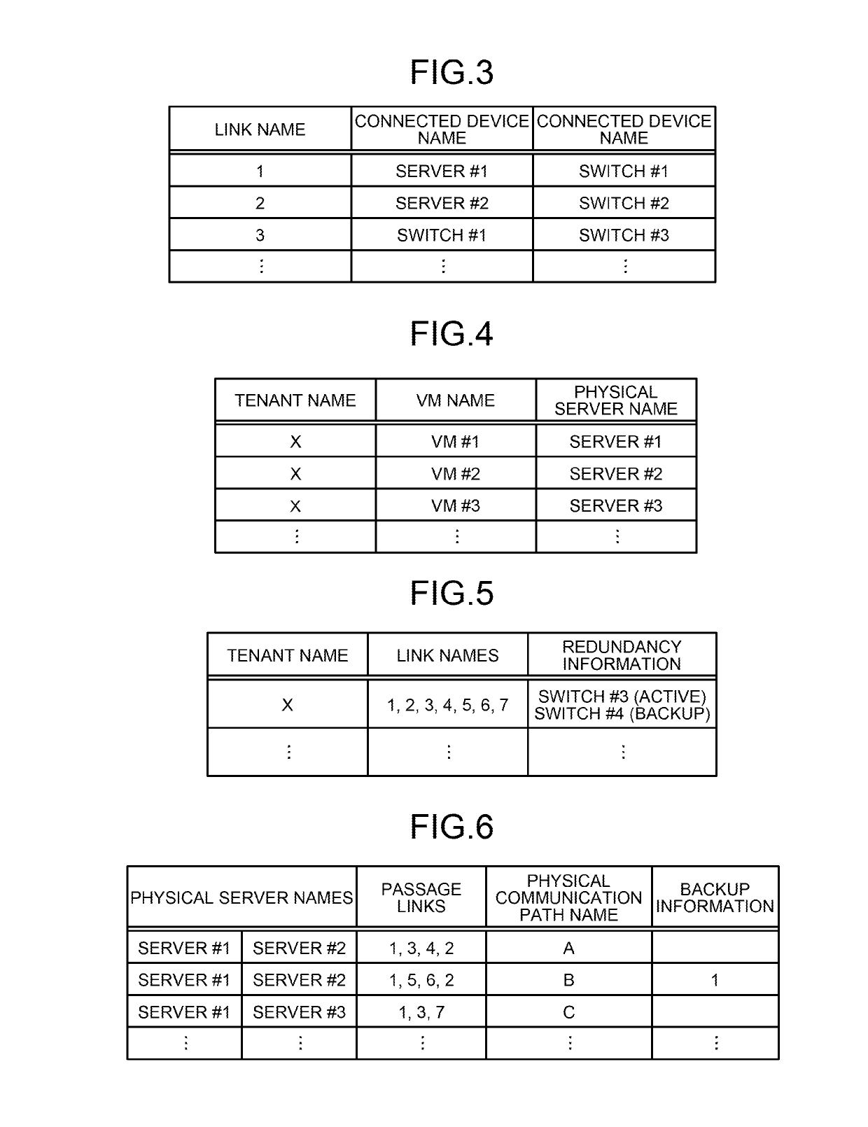

The link table 11 registers therein information on the links 43. FIG. 3 is an example diagram of the link table 11. As illustrated in FIG. 3, the link table 11 registers therein a link name associated with two connected device names for each link 43. The link name is a number for identifying the link 43. The connected device name is an identifier of the server 41 or an identifier of the switch 42 connected to the link 43. The link 43 identified by the number 1, for example, is connected to the server #1 and the switch #1.

The VM table 12 registers therein information on the VMs 44. FIG. 4 is an example diagram of the VM table 12. As illustrated in FIG. 4, the VM table 12 registers therein a tenant name, a VM name, and a physical server name associated with one another for each VM 44. The tenant name is an identifier for identifying a tenant to which the VM 44 is allocated. The VM name is an identifier for identifying the VM 44. The physical server name is an identifier for identifying the server 41 on which the VM 44 operates. The tenant of the VM #1 is X, and the VM #1 operates on the server #1, for example.

The VNW table 13 registers therein information on a virtual network. FIG. 5 is an example diagram of the VNW table 13. As illustrated in FIG. 5, the VNW table 13 registers therein a tenant name, link names, and redundancy information associated with one another for each virtual network. The tenant name is an identifier for identifying a tenant to which the virtual network is allocated. The link names are the numbers of the links 43 included in the virtual network. The redundancy information is information on the switches 42 that achieve redundancy in the virtual network, that is, information on an active switch 42 and a backup switch 42.

A virtual network including the links 43 of the numbers 1 to 7, that is, the links #1 to #7 are allocated to the tenant X, for example. In the virtual network, the switch #3 is an active switch, and the switch #4 is a backup switch.

The association information creating unit 17 creates the path table 14 and the association table 15 on the basis of the information registered in the link table 11, the VM table 12, and the VNW table 13. When the information registered in the link table 11 or the VM table 12 is updated, the association information creating unit 17 updates the path table 14 and the association table 15.

The path table 14 registers therein physical communication paths. FIG. 6 is an example diagram of the path table 14. As illustrated in FIG. 6, the path table 14 registers therein physical server names, passage links, a physical communication path name, and backup information associated with one another for each physical communication path between the servers 41.

The physical server names are identifiers of two servers 41 that communicate with each other. The passage links are the numbers of the links 43 constituting the physical communication path. The physical communication path name is an identifier for identifying the physical communication path. The backup information indicates whether the physical communication path is an active path or a backup path. Backup information of 1 indicates that the physical communication path is a backup path. A physical communication path A between the servers #1 and #2, for example, is composed of the links #1, #3, #4, and #2.

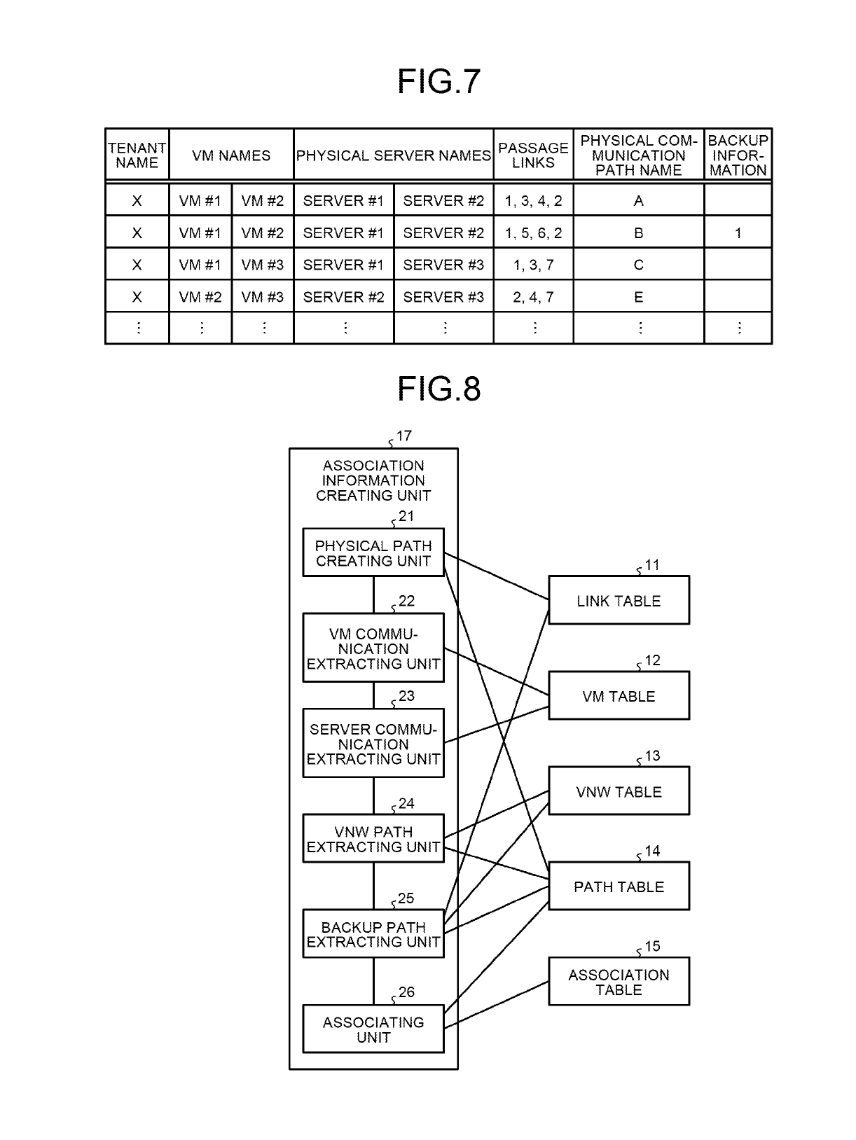

The association table 15 registers therein information for associating communication between VMs with communication between servers. FIG. 7 is an example diagram of the association table 15. As illustrated in FIG. 7, the association table 15 registers therein a tenant name, VM names, physical server names, passage links, a physical communication path name, and backup information associated with one another for each communication between VMs.

The tenant name is an identifier for identifying a tenant that performs communication between VMs. The VM names are identifiers of two VMs 44 that perform communication between VMs. The physical server names are identifiers of servers 41 on which the two VMs 44 that perform communication between VMs operate respectively, that is, servers 41 that perform communication with each other. The passage links are the numbers of the links 43 constituting the physical communication path. The physical communication path name is an identifier for identifying the physical communication path. The backup information indicates whether the physical communication path is an active path or a backup path. The communication between the VMs #1 and #2 for the tenant X, for example, is performed between the servers #1 and #2 on the active physical communication path A composed of the links #1, #3, #4, and #2.

The failure detecting unit 18 detects a failure in a target system 4 an affected range of which is identified when the failure occurs. When detecting a failure in the target system 4, the failure detecting unit 18 notifies the identifying unit 19 of detection of the failure.

When being notified of detection of the failure, the identifying unit 19 identifies affected communication between VMs using the association table 15 and displays information on the identified communication between VMs on the display device. The identifying unit 19 identifies communication between VMs including the link 43 on which the failure occurs in the active physical communication path as the affected communication between VMs. The identifying unit 19 does not identify communication between VMs including the link 43 on which the failure occurs in the backup physical communication path as the affected communication between VMs.

The association information creating unit 17 will be described in greater detail. FIG. 8 is a diagram of a functional diagram of the association information creating unit 17. As illustrated in FIG. 8, the association information creating unit 17 includes a physical path creating unit 21, a VM communication extracting unit 22, a server communication extracting unit 23, a VNW path extracting unit 24, a backup path extracting unit 25, and an associating unit 26.

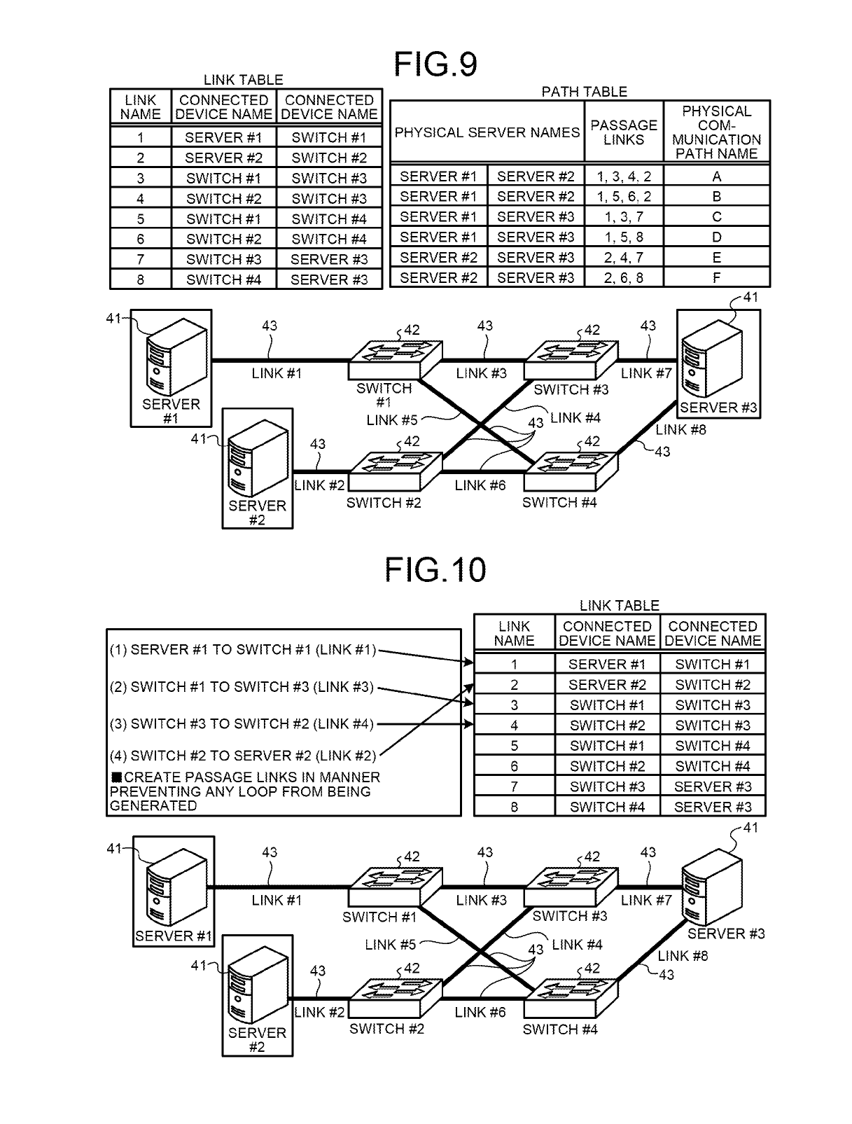

The physical path creating unit 21 refers to the link table 11, thereby creating a physical communication path between two desired servers 41. The physical path creating unit 21 then registers information on the created physical communication path in the path table 14. FIG. 9 is an example diagram of creation of the path table 14 using the link table 11. The physical path creating unit 21 creates all the combinations of communication between two servers 41. In the example illustrated in FIG. 9, the combinations of the servers #1 and #2, the servers #1 and #3, and the servers #2 and #3 are created as all the combinations.

The physical path creating unit 21 searches for the links 43 used by the communication between servers, thereby creating the path table 14. In the example illustrated in FIG. 9, the physical path creating unit 21 searches for two physical communication paths as each of the physical communication paths between the servers #1 and #2, the physical communication paths between the servers #1 and #3, and the physical communication paths between the servers #2 and #3.

FIG. 10 is an example diagram of creation of the passage links. FIG. 10 illustrates an example of creation of the passage links through which data passes in the communication between the servers #1 and #2. The physical path creating unit 21 retrieves the link #1 from the link table 11 as the link 43 extending from the server #1 to the switch #1 (1) and retrieves the link #3 from the link table 11 as the link 43 extending from the switch #1 to the switch #3 (2). The physical path creating unit 21 then retrieves the link #4 from the link table 11 as the link 43 extending from the switch #3 to the switch #2 (3) and retrieves the link #2 from the link table 11 as the link 43 extending from the switch #2 to the server #2 (4).

Subsequently, the physical path creating unit 21 registers 1, 3, 4, and 2 as the passage links between the servers #1 and #2 as illustrated in FIG. 9. The physical path creating unit 21 creates the physical communication path in a manner preventing any loop from being generated.

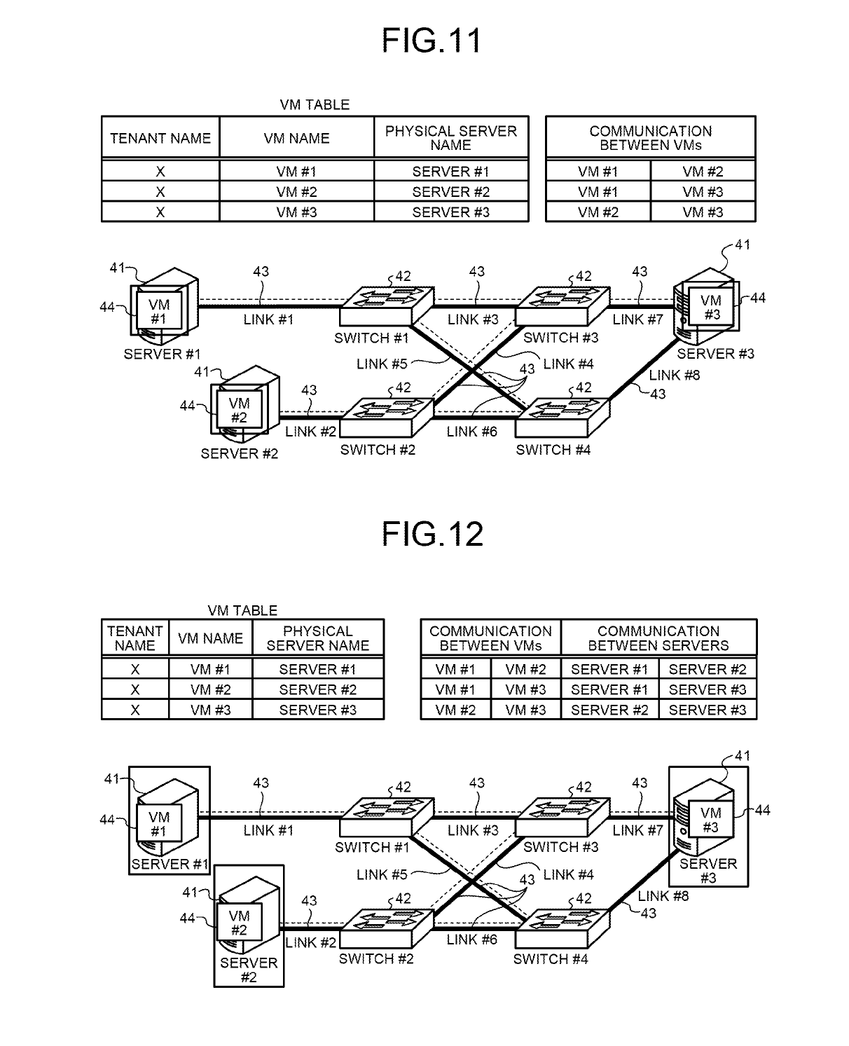

The VM communication extracting unit 22 refers to the VM table 12, thereby creating all the combinations of communication between two desired VMs allocated to the tenant and extracting communication between VMs. FIG. 11 is an example diagram of extraction of communication between VMs. As illustrated in FIG. 11, the VM communication extracting unit 22 extracts communication between the VMs #1 and #2, communication between the VMs #1 and #3, and communication between the VMs #2 and #3 as the communication between the three VMs #1 to #3.

The server communication extracting unit 23 extracts communication between servers corresponding to the communication between VMs extracted by the VM communication extracting unit 22. FIG. 12 is an example diagram of extraction of communication between servers. As illustrated in FIG. 12, the VM #1 corresponds to the server #1, the VM #2 corresponds to the server #2, and the VM #3 corresponds to the server #3. This correspondence allows the server communication extracting unit 23, for example, to extract communication between the servers #1 and #2 as the communication between servers corresponding to the communication between the VMs #1 and #2.

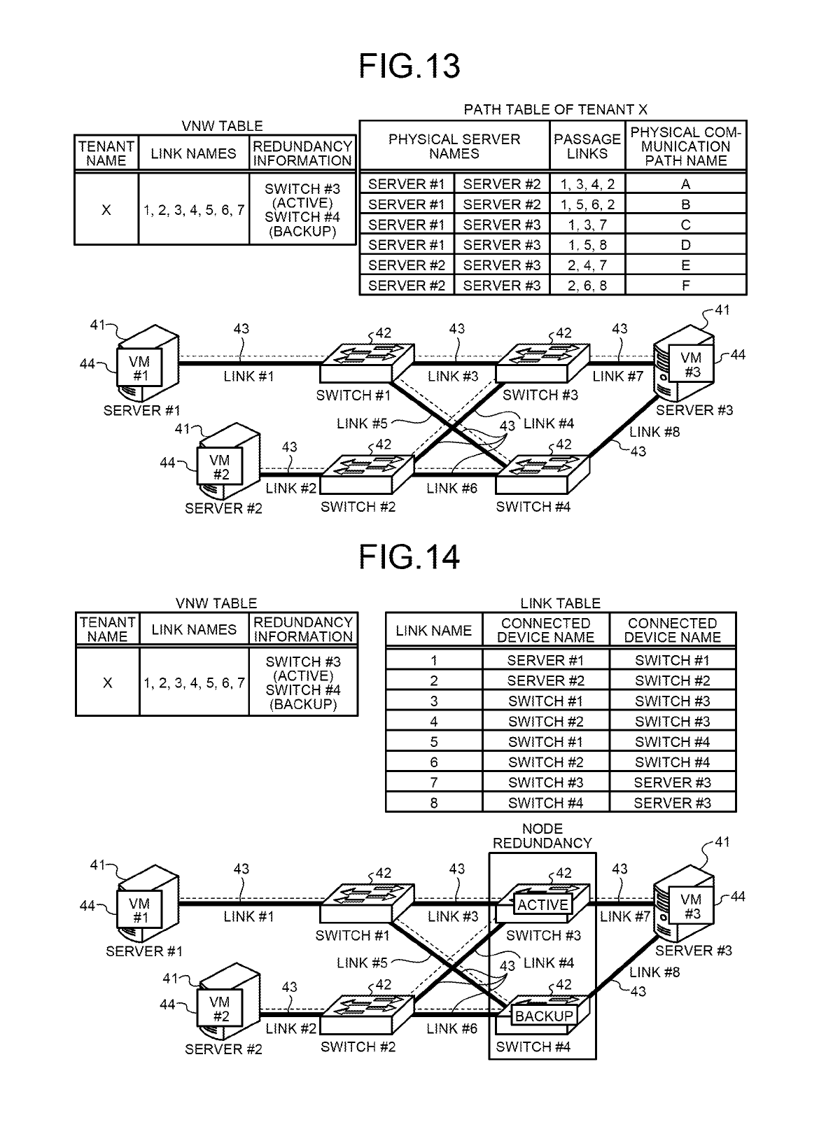

The VNW path extracting unit 24 refers to the VNW table 13, thereby extracting physical communication paths on the virtual network set for the tenant out of the physical communication paths associated with the communication between VMs by the server communication extracting unit 23. FIG. 13 is an example diagram of extraction of physical communication paths on the virtual network.

As illustrated in FIG. 13, for example, the VNW path extracting unit 24 extracts the links #1 to #7 from the VNW table 13 as the links 43 on the virtual network set for the tenant X. The VNW path extracting unit 24 then deletes a physical communication path including a link 43 other than the extracted links #1 to #7 in the passage links from the path table 14 of the tenant X. Because a link #8 in FIG. 13 is not extracted as the communication path on the virtual network set for the tenant X, the VNW path extracting unit 24 deletes physical communication paths D and F from the path table 14 of the tenant X.

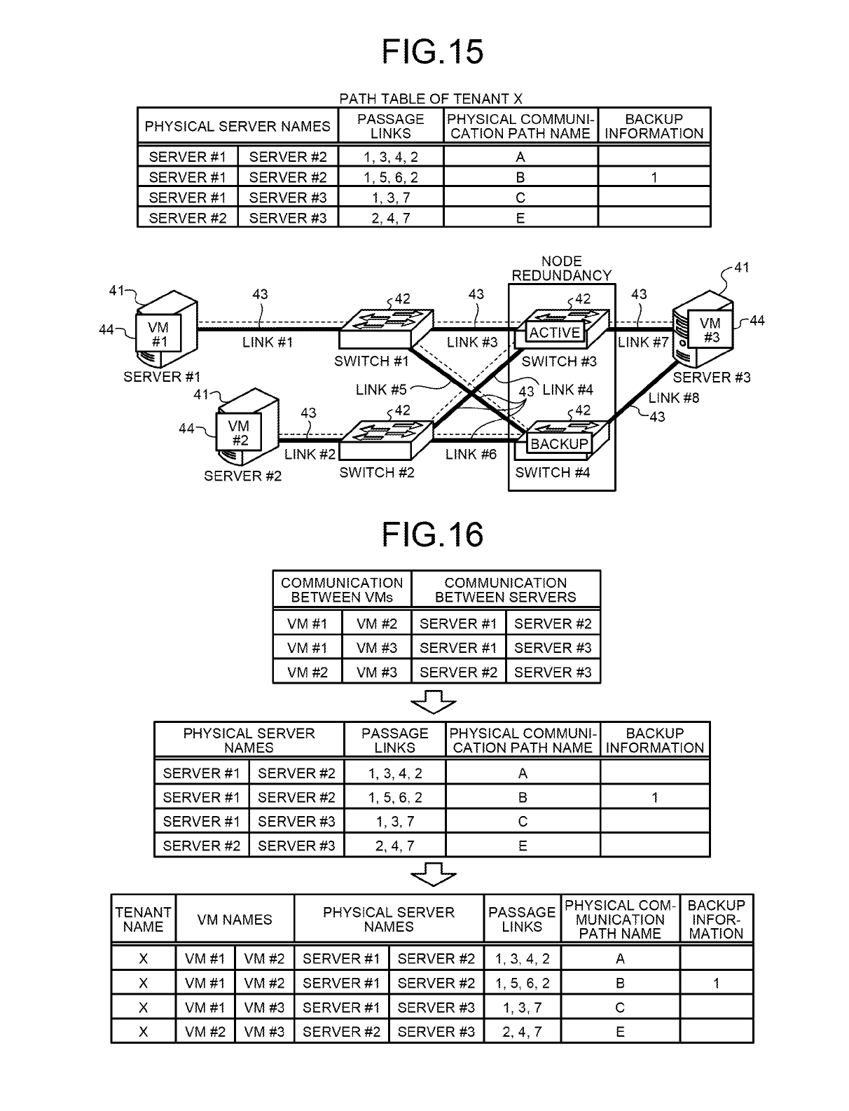

In a case where the virtual network has a redundant configuration, the backup path extracting unit 25 extracts a physical communication path used as a backup path. FIGS. 14 and 15 are example diagrams of extraction of a backup path. As illustrated in FIG. 14, the backup path extracting unit 25 extracts the switch #4 set as a backup system from the VNW table 13. The backup path extracting unit 25 then extracts the links #5, #6, and #8 connected to the switch #4 from the link table 11.

The backup path extracting unit 25 determines a physical communication path including the link #5, #6, or #8 to be a backup path and defines the backup information thereof in the path table 14 as 1. Because a physical communication path B includes the links #5 and #6 in FIG. 15, the backup path extracting unit 25 determines the physical communication path B to be a backup path.

The associating unit 26 associates communication between VMs with a physical communication path or physical communication paths, thereby creating the association table 15. FIG. 16 is an example diagram of association of the communication between VMs with the physical communication path or the physical communication paths. The associating unit 26 identifies communication between servers associated with the communication between VMs by the server communication extracting unit 23 and extracts the identified communication between servers from the path table 14. In FIG. 16, for example, the associating unit 26 identifies the communication between the servers #1 and #2 corresponding to the communication between the VMs #1 and #2, so as to extract the physical communication paths A and B from the path table 14.

Subsequently, the associating unit 26 associates the extracted physical communication paths with the communication between VMs, thereby creating the association table 15. In FIG. 16, for example, the associating unit 26 associates the physical communication paths A and B with the communication between the VMs #1 and #2. The physical communication path B serves as a backup path.

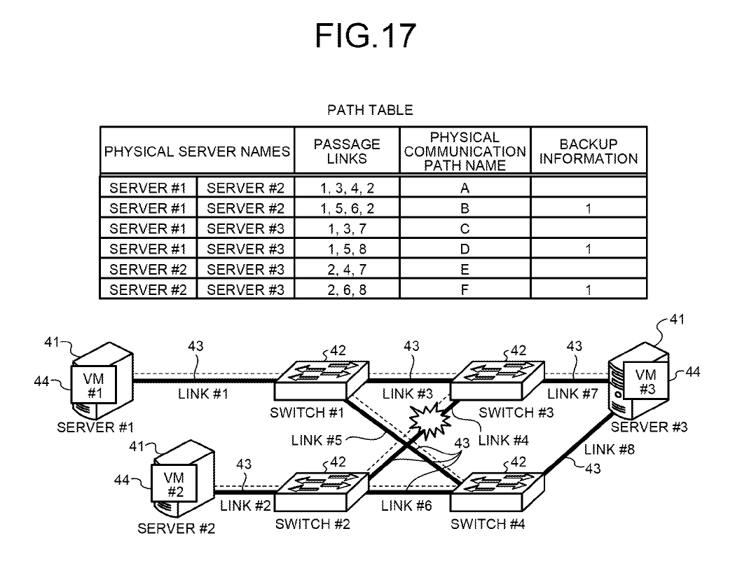

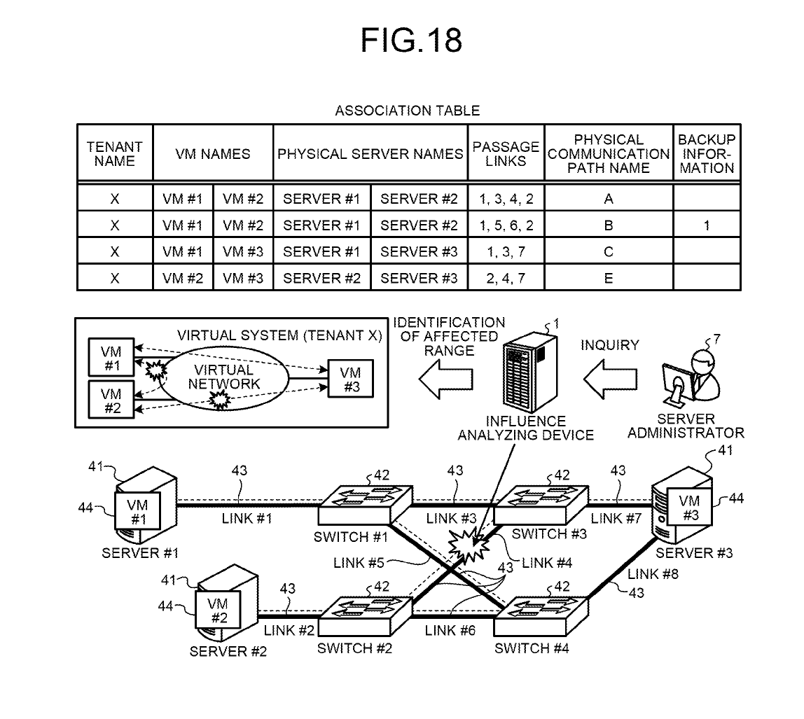

The following describes an example of identification of a failure-affected range using the association table 15. FIGS. 17 and 18 are example diagrams of identification of an affected range in a network infrastructure failure. Let us assume a case where a failure occurs in the link #4 as illustrated in FIG. 17. The identifying unit 19 refers to the path table 14, thereby identifying a physical communication path passing through the failure link #4. Because the physical communication path A and a physical communication path E include the link #4 in FIG. 17, the identifying unit 19 identifies the physical communication paths A and E.

Subsequently, the identifying unit 19 refers to the association table 15, thereby identifying communication between VMs corresponding to each of the identified physical communication paths. In FIG. 18, the identifying unit 19 identifies the communication between the VMs #1 and #2 as the communication between VMs corresponding to the physical communication path A and identifies the communication between the VMs #2 and #3 as the communication between VMs corresponding to the physical communication path E.

When the server administrator 7 inquires of the influence analyzing device 1 about an affected range, the influence analyzing device 1 displays the communication between the VMs #1 and #2 and the communication between the VMs #2 and #3 as the affected communication between VMs on the display device. Because the information in the path table 14 is included in the association table 15, the identifying unit 19 may identify the affected range using the association table 15 alone.

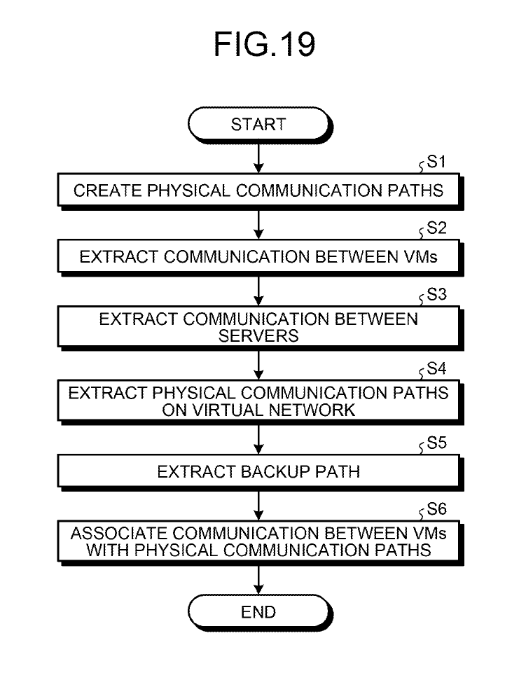

The following describes a flow of association of the communication between VMs with the physical communication paths. FIG. 19 is a flowchart of association of the communication between VMs with the physical communication paths. As illustrated in FIG. 19, the physical path creating unit 21 creates physical communication paths (Step S1) and registers them in the path table 14.

The VM communication extracting unit 22 extracts communication between VMs (Step S2). The server communication extracting unit 23 extracts communication between servers corresponding to the communication between VMs extracted by the VM communication extracting unit 22 (Step S3). The VNW path extracting unit 24 extracts physical communication paths on a virtual network set for a tenant out of the physical communication paths for the communication between servers extracted by the server communication extracting unit 23 (Step S4). The VNW path extracting unit 24 deletes the other physical communication paths from the path table 14.

In a case where the virtual network has a redundant configuration, the backup path extracting unit 25 extracts a backup path (Step S5) and updates the path table 14. The associating unit 26 associates the communication between VMs with the physical communication paths (Step S6), thereby creating the association table 15.

As described above, the influence analyzing device 1 associates the communication between VMs with the physical communication paths, so as to identify the VMs 44 affected when a failure occurs in the network infrastructure using the association table 15.

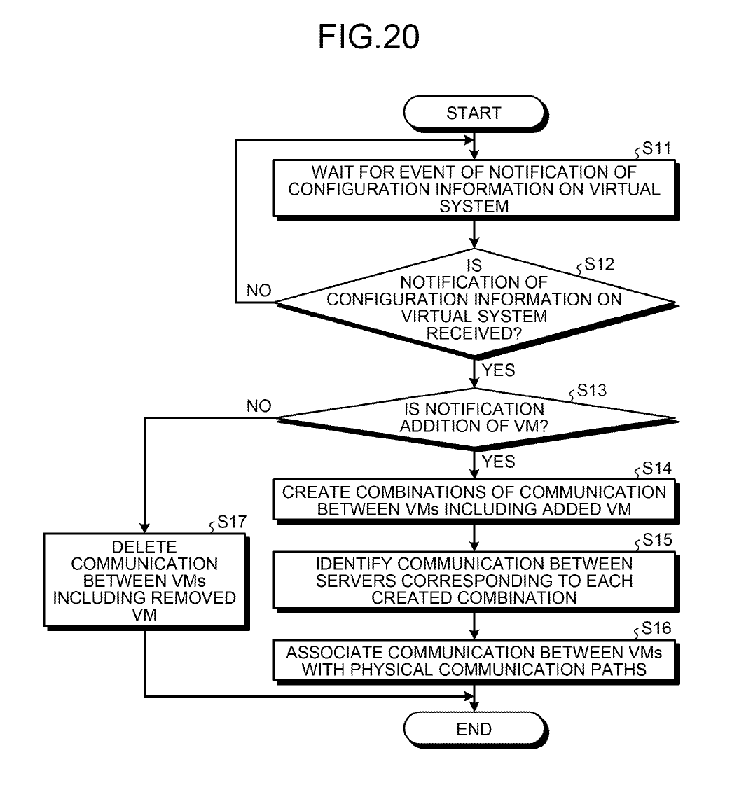

The following describes a flow of processing performed in response to notification of configuration information on the virtual system. FIG. 20 is a flowchart of processing performed in response to notification of configuration information on the virtual system. As illustrated in FIG. 20, the configuration information receiving unit 16 waits for an event of notification of the configuration information on the virtual system (Step S11). The configuration information receiving unit 16 determines whether it has received notification of the configuration information on the virtual system (Step S12). If the configuration information receiving unit 16 determines that it has not received the notification, it performs the processing at Step S11 again.

By contrast, if the configuration information receiving unit 16 determines that it has received notification of the configuration information, the configuration information receiving unit 16 determines whether the notification is addition of a VM 44 (Step S13). If the notification is addition of a VM 44, the VM communication extracting unit 22 creates combinations of communication between VMs including the added VM 44 (Step S14). The server communication extracting unit 23 identifies communication between servers corresponding to each of the combinations created by the VM communication extracting unit 22 (Step S15). The associating unit 26 associates the communication between VMs with the physical communication paths (Step S16) and updates the association table 15.

By contrast, if the notification is not addition of a VM 44, the notification is determined to be removal of a VM 44. Thus, the associating unit 26 deletes communication between VMs including the removed VM 44 from the association table 15 (Step S17).

As described above, the influence analyzing device 1 updates the association table 15 when a VM 44 is added or removed, so as to accurately identify a range affected by a failure even in a case where a VM 44 is added or removed.

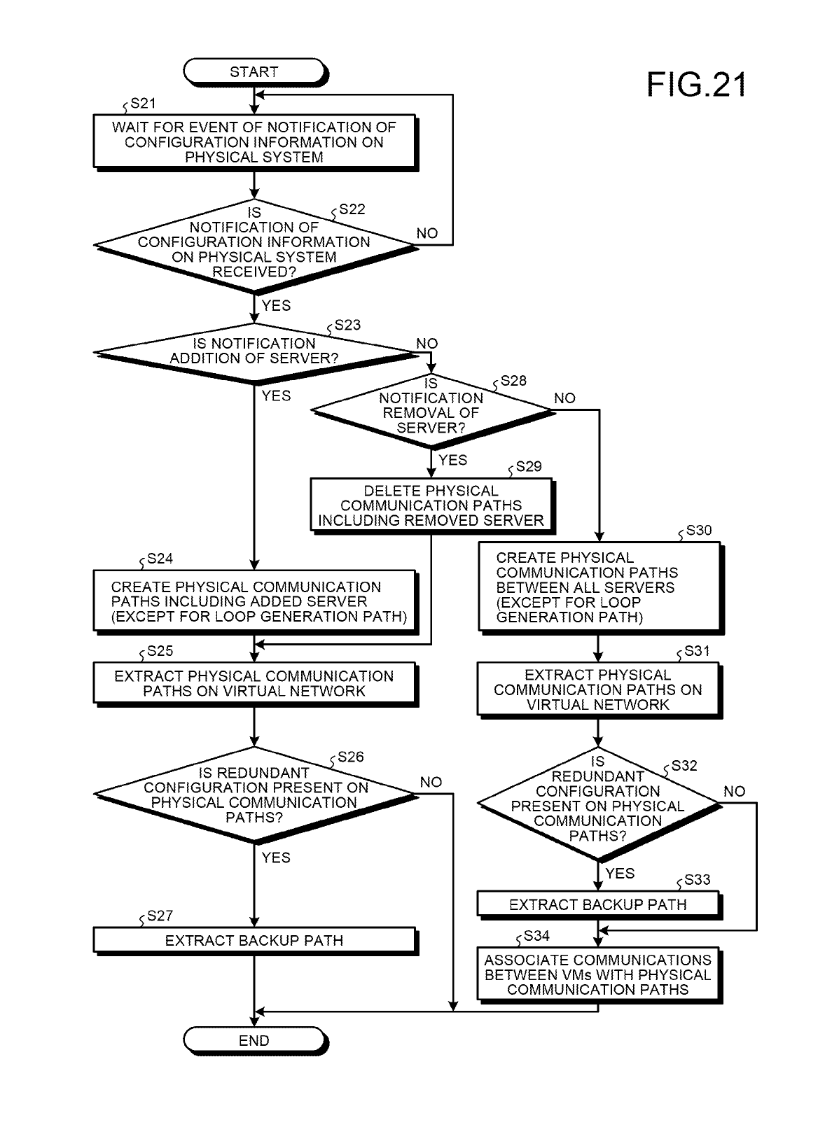

The following describes a flow of processing performed in response to notification of configuration information on the physical system. FIG. 21 is a flowchart of processing performed in response to notification of configuration information on the physical system. As illustrated in FIG. 21, the configuration information receiving unit 16 waits for an event of notification of the configuration information on the physical system (Step S21). The configuration information receiving unit 16 determines whether it has received notification of the configuration information on the physical system (Step S22). If the configuration information receiving unit 16 determines that it has not received the notification, it performs the processing at Step S21 again.

By contrast, if the configuration information receiving unit 16 determines that it has received notification of the configuration information, the configuration information receiving unit 16 determines whether the notification is addition of a server 41 (Step S23). If the notification is addition of a server 41, the physical path creating unit 21 creates physical communication paths including the added server 41 (Step S24) and updates the path table 14. The physical path creating unit 21, however, creates no loop generation path.

The VNW path extracting unit 24 extracts physical communication paths on the virtual network (Step S25) and updates the path table 14. The backup path extracting unit 25 determines whether a redundant configuration is present on the physical communication paths (Step S26). If a redundant configuration is present, the backup path extracting unit 25 extracts a backup path (Step S27) and updates the path table 14.

By contrast, if the notification is not addition of a server 41, the configuration information receiving unit 16 determines whether the notification is removal of a server 41 (Step S28). If the notification is removal of a server 41, the physical path creating unit 21 deletes physical communication paths including the removed server 41 from the path table 14 (Step S29) and performs processing at Step S25.

By contrast, if the notification is not removal of a server 41, the notification is determined to be addition or removal of a network device. The physical path creating unit 21 creates physical communication paths between all the servers 41 (Step S30) and updates the path table 14. The physical path creating unit 21, however, creates no loop generation path.

The VNW path extracting unit 24 extracts physical communication paths on the virtual network (Step S31) and updates the path table 14. The backup path extracting unit 25 determines whether a redundant configuration is present on the physical communication paths (Step S32). If a redundant configuration is present, the backup path extracting unit 25 extracts a backup path (Step S33) and updates the path table 14. The associating unit 26 associates the communication between VMs with the physical communication paths (Step S34) and updates the association table 15.

As described above, the influence analyzing device 1 updates the relating tables when the physical system is changed, so as to accurately identify a range affected by a failure even in a case where the physical system is changed.

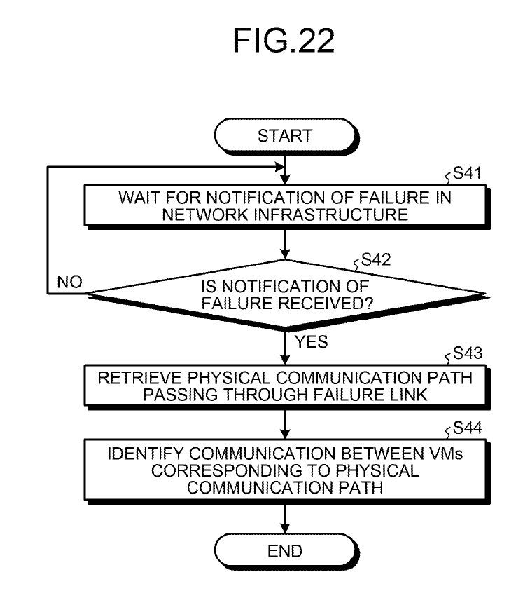

The following describes a flow of processing for identifying a failure-affected range. FIG. 22 is a flowchart of processing for identifying a failure-affected range. As illustrated in FIG. 22, the identifying unit 19 waits for notification of a failure in the network infrastructure (Step S41). The identifying unit 19 determines whether it has received notification of a failure (Step S42). If the identifying unit 19 determines that it has not received the notification, it performs the processing at Step S41 again.

By contrast, if the identifying unit 19 determines that it has received notification of a failure, the identifying unit 19 retrieves a physical communication path passing through the failure link 43 from the association table 15 (Step S43). The identifying unit 19 identifies communication between VMs corresponding to the retrieved physical communication path (Step S44).

As described above, the identifying unit 19 identifies the communication between VMs affected by the failure using the association table 15. This identification allows the influence analyzing device 1 to display the affected communication between VMs on the display device in response to an inquiry from the administrator about an affected range.

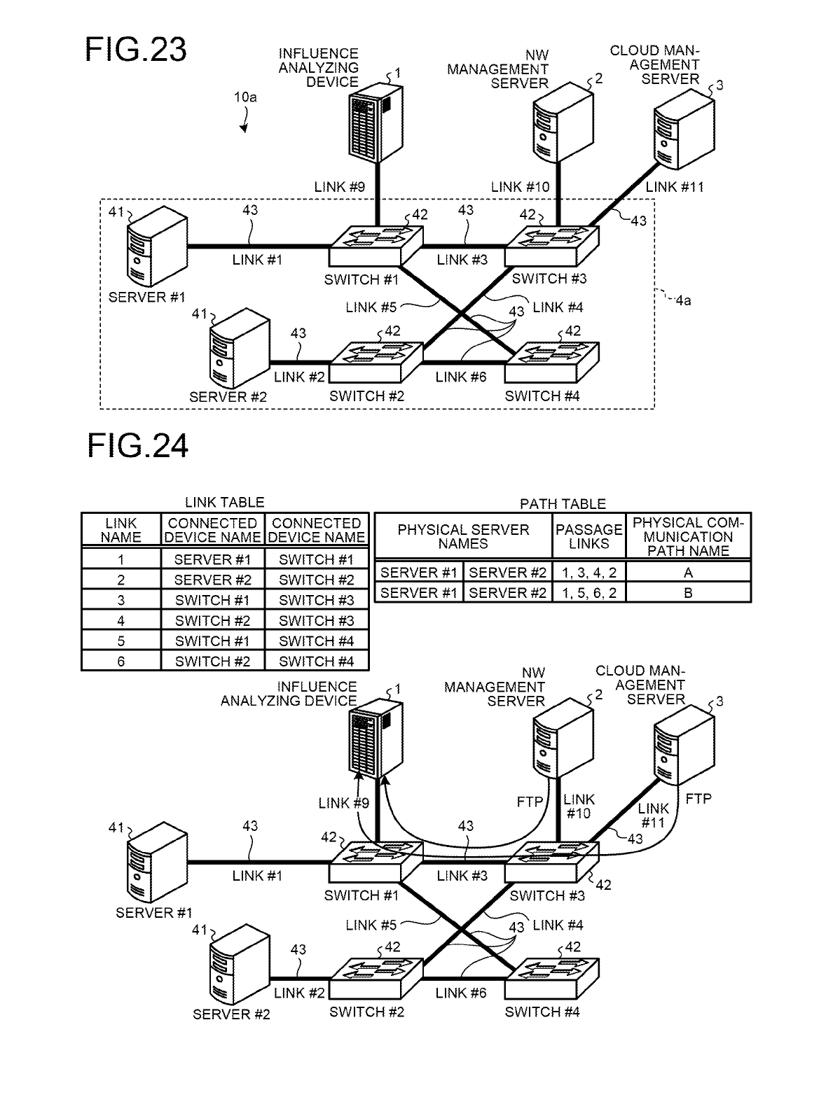

The following describes the processing performed by the influence analyzing device 1 with reference to an example. FIG. 23 is a diagram of a physical configuration of an information processing system 10a used as the example. As illustrated in FIG. 23, the information processing system 10a includes the influence analyzing device 1, the NW management server 2, the cloud management server 3, and a target system 4a. The target system 4a includes two servers #1 and #2, four switches #1 to #4, nine links #1 to #6 and #9 to #11.

FIG. 24 is a diagram of the path table 14 created from link information on the target system 4a illustrated in FIG. 23. The configuration information receiving unit 16 acquires physical infrastructure configuration information from the NW management server 2 and the cloud management server 3 by File Transfer Protocol (FTP), thereby creating the link table 11. The physical path creating unit 21 creates the path table 14 from the link table 11. The physical infrastructure configuration information is link information on links connected to the switch 42 and link information on links connected to the server 41. The link information on links connected to the switch 42 is transmitted from the NW management server 2, whereas the link information on links connected to the server 41 is transmitted from the cloud management server 3.

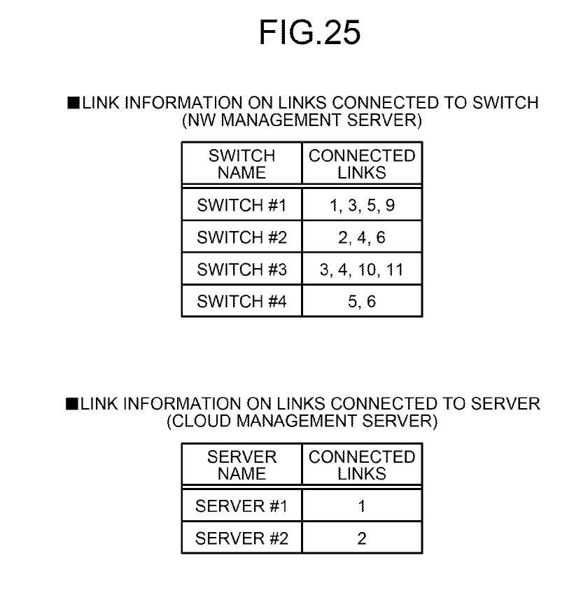

FIG. 25 is a diagram of the physical infrastructure configuration information on the target system 4a illustrated in FIG. 23. In the link information on links connected to the switch 42 illustrated in FIG. 25, a switch name is associated with connected links. The switch name is a name for identifying a switch 42. The connected links are links 43 connected to the switch 42 identified by the switch name. The switch #1, for example, is connected to the links #1, #3, #5, and #9.

In the link information on links connected to the server 41, a server name is associated with connected links. The server name is a name for identifying a server 41. The connected links are links 43 connected to the server 41 identified by the server name. The server #1 is connected to the link #1, and the server #2 is connected to the link #2, for example.

By converting the information illustrated in FIG. 25 into information on each link 43, the link table 11 illustrated in FIG. 24 is obtained. The devices connected to the link #1, for example, are the switch #1 and the server #1. On the basis of the link table 11 illustrated in FIG. 24, the physical communication paths A and B are obtained as the physical communication path between the servers #1 and #2. The physical communication path A is composed of the links #1, #3, #4, and #2, whereas the physical communication path B is composed of the links #1, #5, #6, and #2.

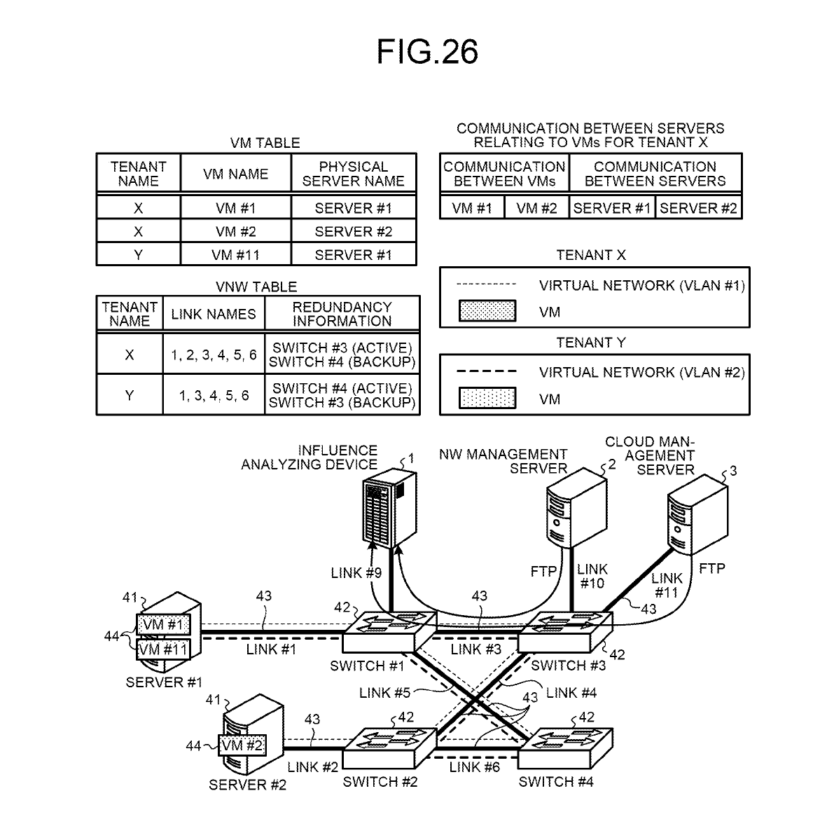

FIG. 26 is an example diagram of extraction of communication between servers when the VMs 44 are created. The configuration information receiving unit 16 receives VM configuration information from the cloud management server 3 to create the VM table 12. The configuration information receiving unit 16 receives VNW configuration information from the NW management server 2 to create the VNW table 13. The configuration information receiving unit 16, for example, registers the VM #1 that operates on the server #1 and the VM #2 that operates on the server #2 in the VM table 12 for the tenant X. The configuration information receiving unit 16 also registers information on the virtual network (VLAN #1) composed of the links #1 to #6 and having the switch #4 as a backup switch in the VNW table 13.

The VM communication extracting unit 22 extracts communication between VMs on the basis of the VM table 12, and the server communication extracting unit 23 extracts communication between servers corresponding to the communication between VMs. In FIG. 26, the VM communication extracting unit 22 extracts the communication between the VMs #1 and #2 as the communication between VMs for the tenant X. The server communication extracting unit 23 extracts the communication between the servers #1 and #2 as the communication between servers corresponding to the communication between the VMs #1 and #2. Because a tenant Y has one VM 44 alone, the server communication extracting unit 23 extracts no communication between VMs.

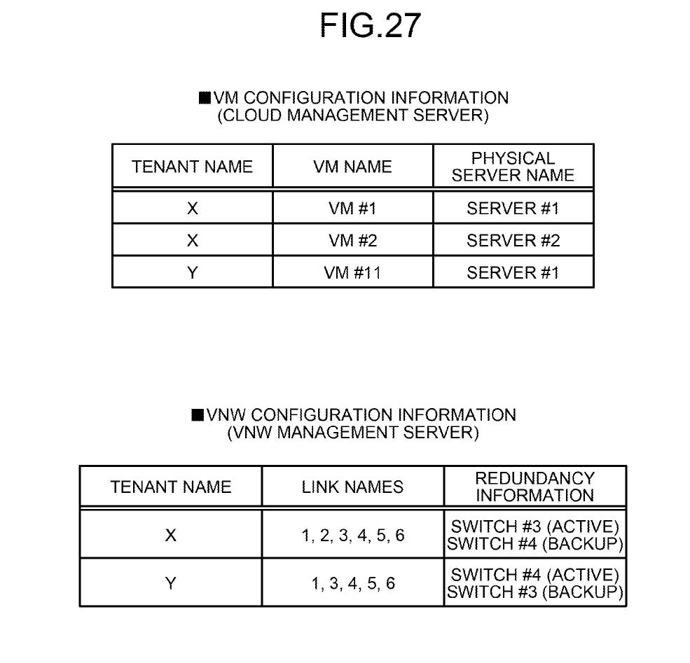

FIG. 27 is an example diagram of the VM configuration information and the VNW configuration information received by the configuration information receiving unit 16. As illustrated in FIG. 27, the VM configuration information corresponds to the information registered in the VM table 12, whereas the VNW configuration information corresponds to the information registered in the VNW table 13.

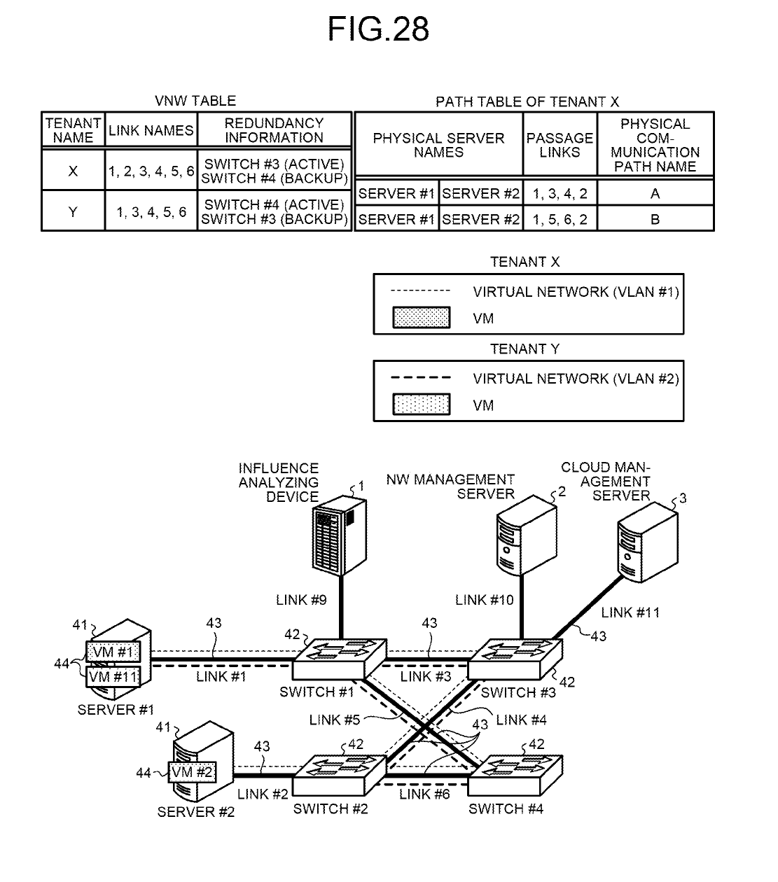

FIG. 28 is an example diagram of extraction of physical communication paths on which the virtual network is set. The VNW path extracting unit 24 deletes physical communication paths including the link 43 not contained in the VNW table 13, that is, the link 43 on which the virtual network is not set from the path table 14. Because the physical communication paths A and B in FIG. 28 include no link 43 on which the virtual network for the tenant X is not set, the VNW path extracting unit 24 extracts them as the physical communication paths on which the virtual network is set.

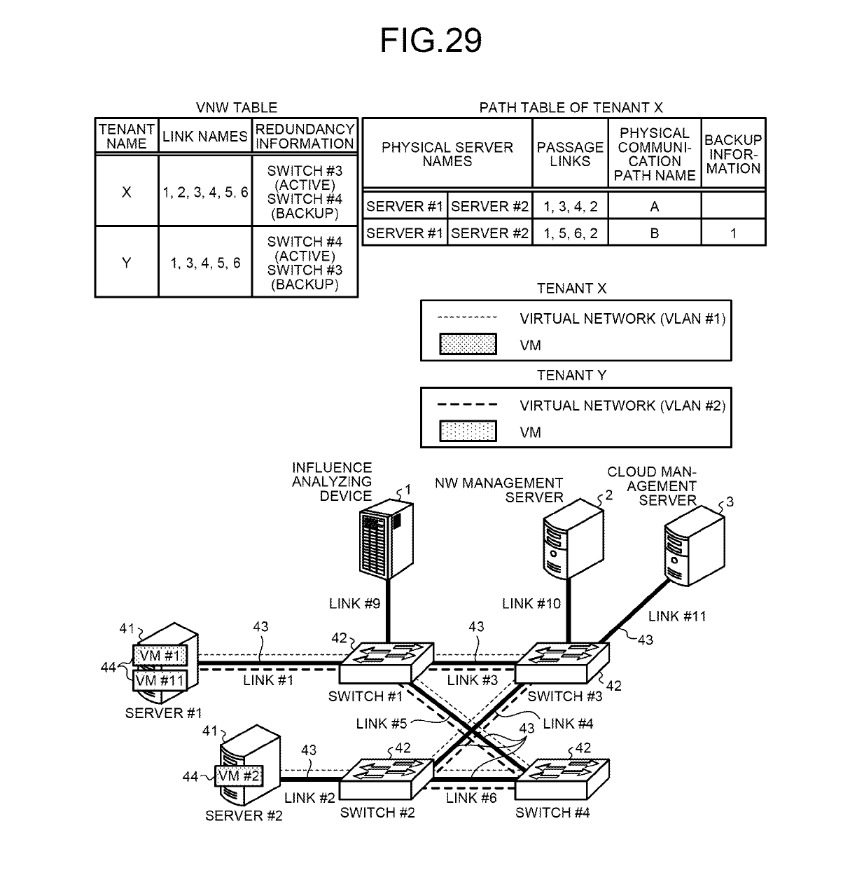

FIG. 29 is an example diagram of extraction of a backup path. The backup path extracting unit 25 defines the backup information on a physical communication path passing through the backup switch 42 as 1 in the path table 14. As indicated in the VNW table 13, the switch #4 is a backup switch for the tenant X. The switch #4 is connected to the links #5 and #6. This connection allows the backup path extracting unit 25 to extract the physical communication path B including the links #5 and #6 as a backup path and define the backup information on the physical communication path B as 1.

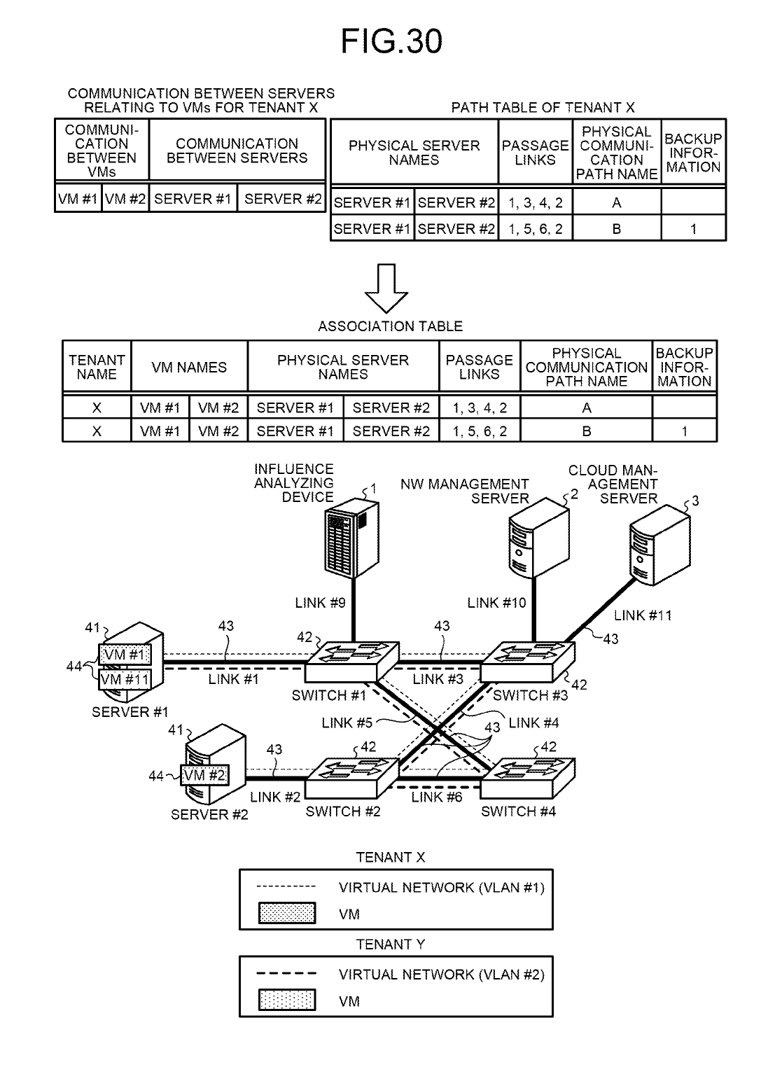

FIG. 30 is an example diagram of creation of the association table 15. The associating unit 26 creates the association table 15 on the basis of the information on the communication between servers corresponding to the communication between VMs and on the information in the path table 14. In FIG. 30, the communication between the servers #1 and #2 corresponds to the communication between the VMs #1 and #2 and is established by the physical communication path A or the physical communication path B. This correspondence allows the associating unit 26 to associate the physical communication paths A and B with the communication between the VMs #1 and #2 in the association table 15.

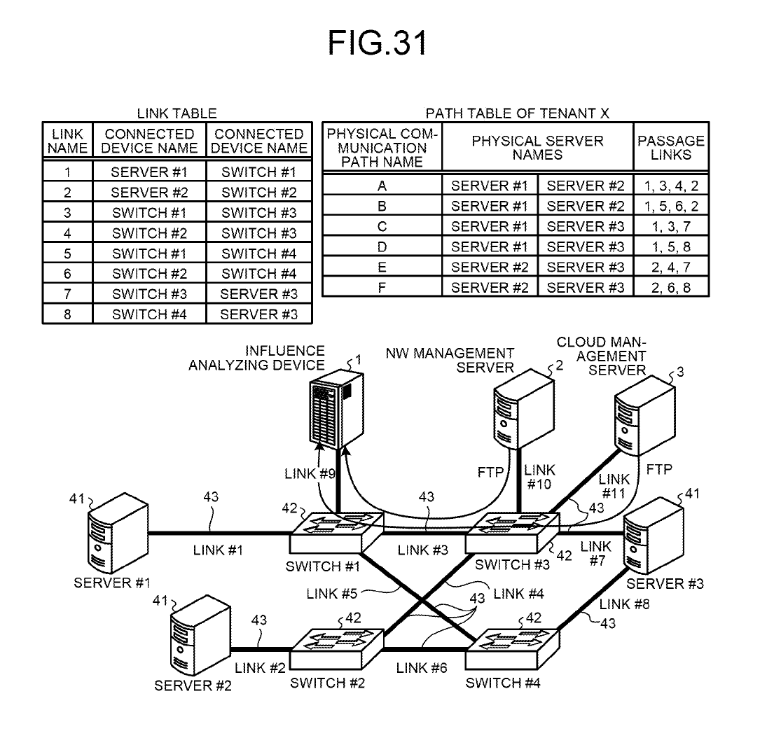

FIG. 31 is an example diagram of update of the path table 14 when a server 41 is added. In FIG. 31, the server #3 and the links #7 and #8 connected to the server #3 are added. The configuration information receiving unit 16 receives the physical infrastructure configuration information from the NW management server 2 and the cloud management server 3 and updates the link table 11. The links #7 and #8 are added to the link table 11.

On the basis of the updated link table 11, the physical path creating unit 21 updates the path table 14. In FIG. 31, the physical communication paths C and D are added as the physical communication path between the servers #1 and #3, and the physical communication paths E and F are added as the physical communication path between the servers #2 and #3.

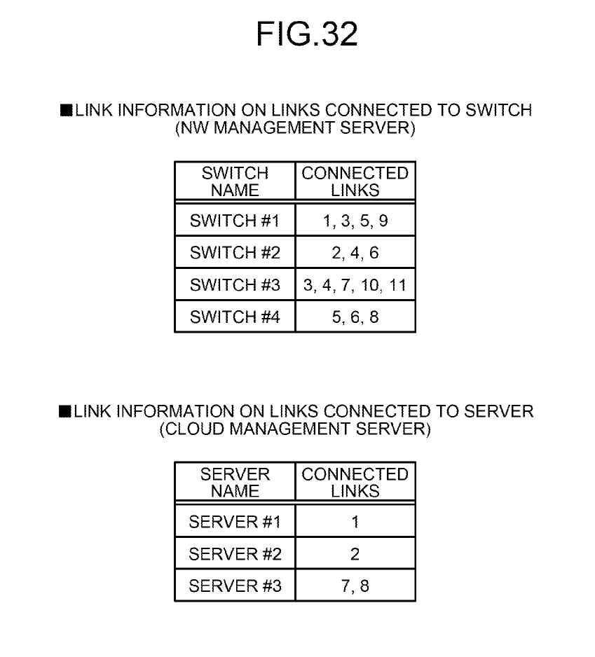

FIG. 32 is an example diagram of the physical infrastructure configuration information transmitted from the NW management server 2 and the cloud management server 3. In the link information on links connected to the switch 42 illustrated in FIG. 32, the link #7 is added as the link 43 connected to the switch #3, and the link #8 is added as the link 43 connected to the switch #4. In the link information on links connected to the server 41, the links #7 and #8 are added as the link 43 connected to the server #3.

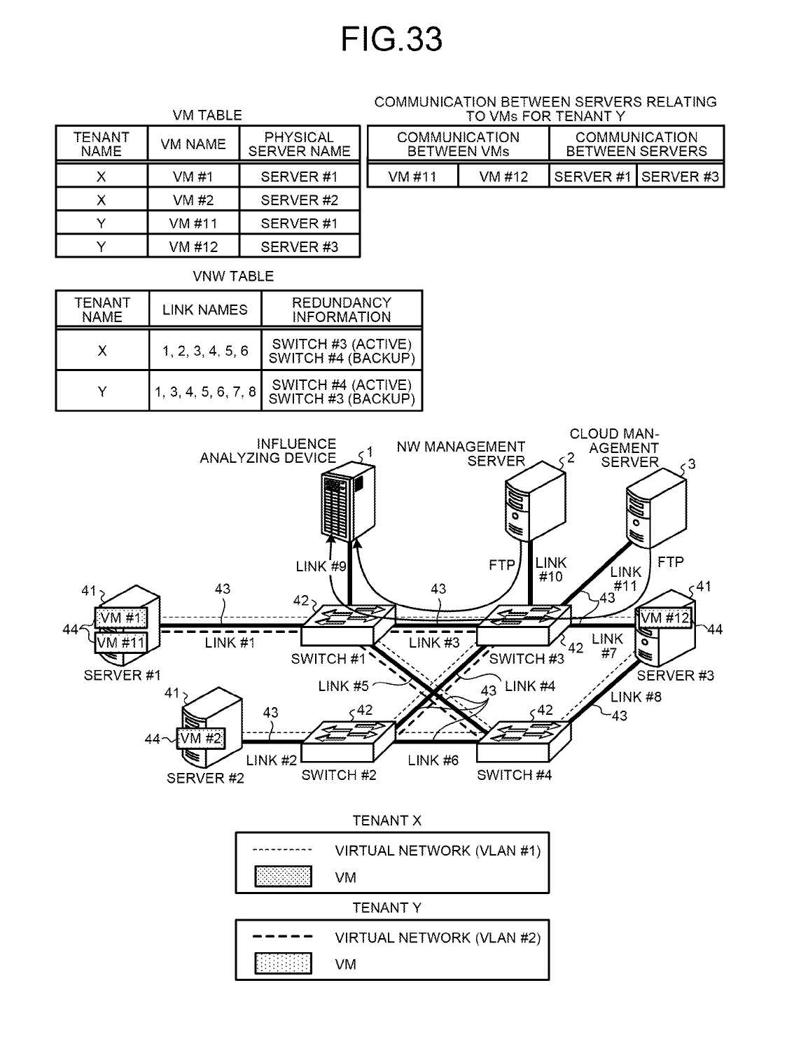

FIG. 33 is an example diagram of extraction of communication between servers when a VM 44 is added. In FIG. 33, a VM #12 that operates on the server #3 is added. The configuration information receiving unit 16 receives the VM configuration information from the cloud management server 3 to update the VM table 12 and receives the VNW configuration information from the NW management server 2 to update the VNW table 13. In FIG. 33, the VM #12 that operates on the server #3 for the tenant Y is added to the VM table 12. The links #7 and #8 are added to the VNW table 13 as the link 43 on which a virtual network (VLAN #2) for the tenant Y is set.

On the basis of the VM table 12, the VM communication extracting unit 22 extracts communication between VMs for the tenant Y. The server communication extracting unit 23 extracts communication between servers corresponding to the communication between VMs. In FIG. 33, the VM communication extracting unit 22 extracts communication between the VMs #11 and #12 as the communication between VMs for the tenant Y. The server communication extracting unit 23 extracts communication between the servers #1 and #3 as the communication between servers corresponding to the communication between the VMs #11 and #12.

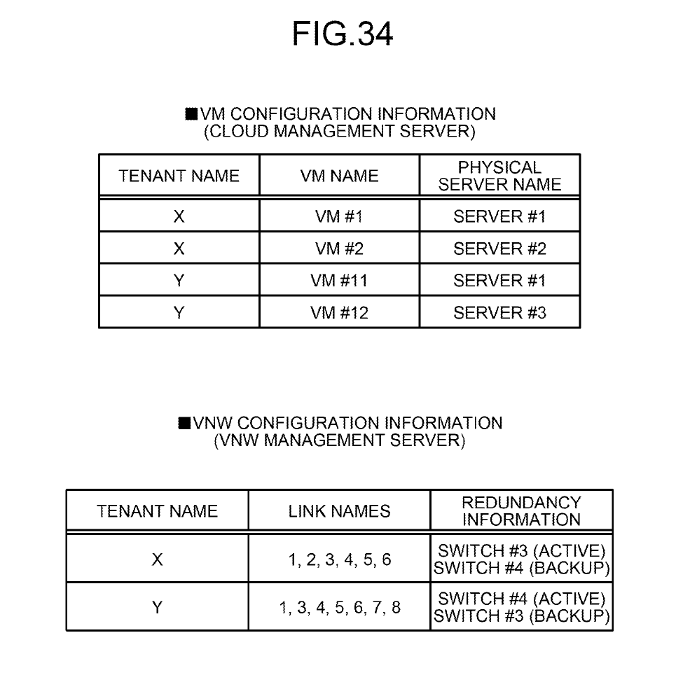

FIG. 34 is an example diagram of the VM configuration information and the VNW configuration information received by the configuration information receiving unit 16. As illustrated in FIG. 34, the VM configuration information corresponds to the information registered in the VM table 12, whereas the VNW configuration information corresponds to the information registered in the VNW table 13.

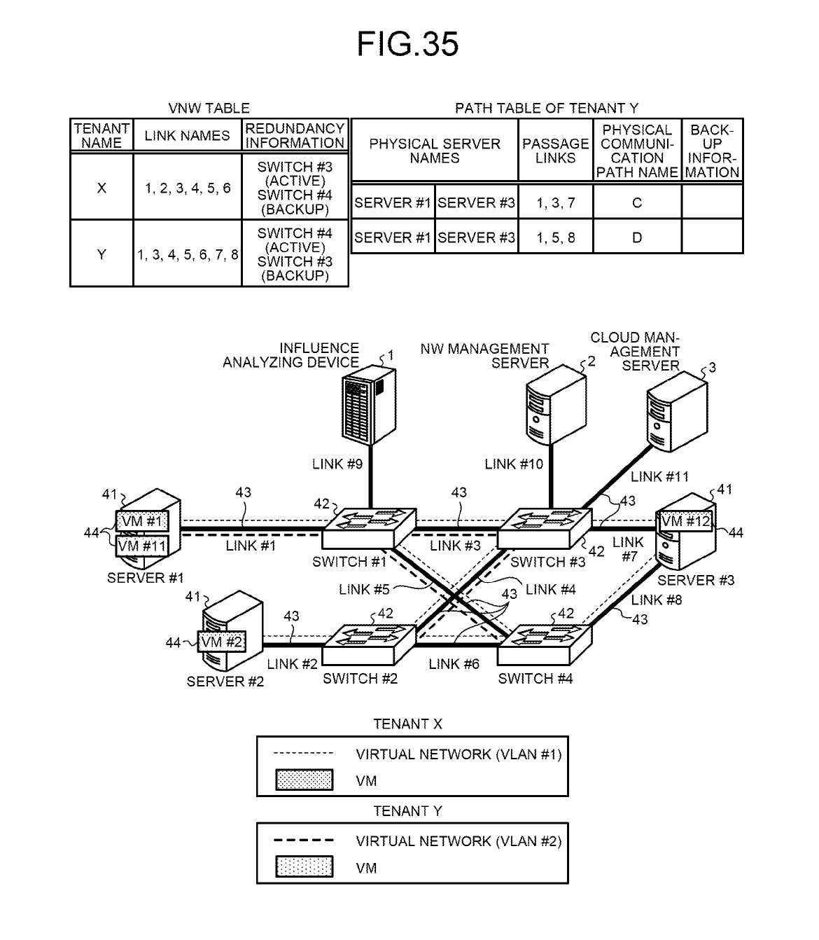

FIG. 35 is an example diagram of update of the path table when the VM 44 is added. The VNW path extracting unit 24 identifies the physical communication path on which the VLAN #2 for the tenant Y is set and updates the path table 14. In FIG. 35, the VNW path extracting unit 24 identifies the physical communication paths C and D as the physical communication path for the tenant Y and updates the path table 14.

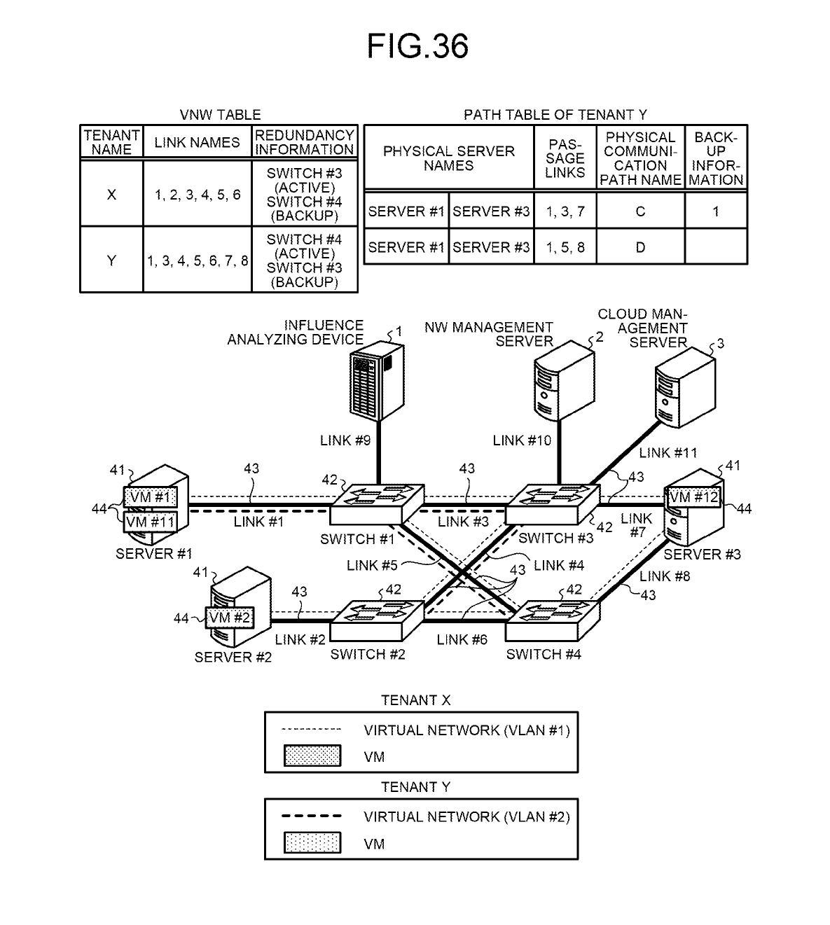

FIG. 36 is an example diagram of extraction of a backup path when the VM is added. The backup path extracting unit 25 extracts a physical communication path passing through the backup switch 42 as a backup path. In FIG. 36, the backup path extracting unit 25 extracts the physical communication path C passing through the switch #3 served as a backup switch for the tenant Y and defines the backup information thereof in the path table 14 as 1.

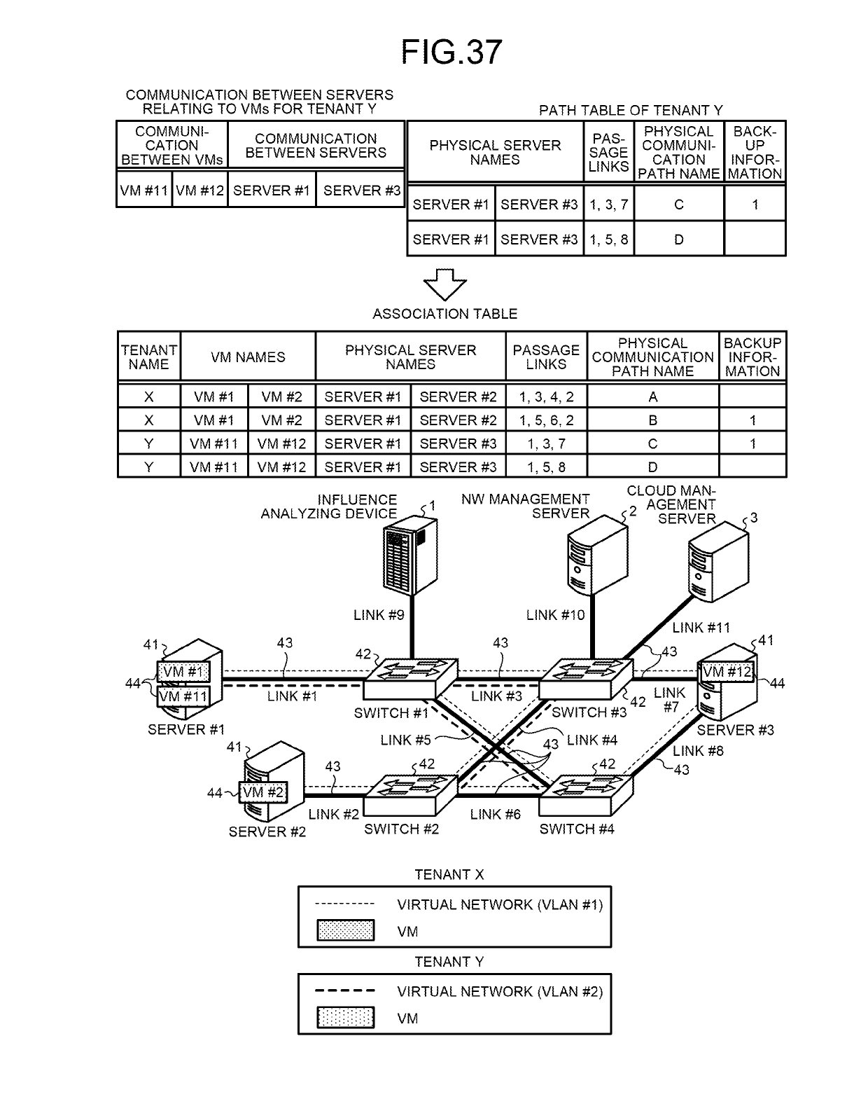

FIG. 37 is an example diagram of update of the association table 15 when the VM 44 is added. The associating unit 26 updates the association table 15 on the basis of the information on the communication between servers relating to the VMs 44 for the tenant Y and on the path table 14 of the tenant Y. In FIG. 37, the associating unit 26 associates the physical communication paths C and D with the communication between the VMs #11 and #12 and adds them to the association table 15.

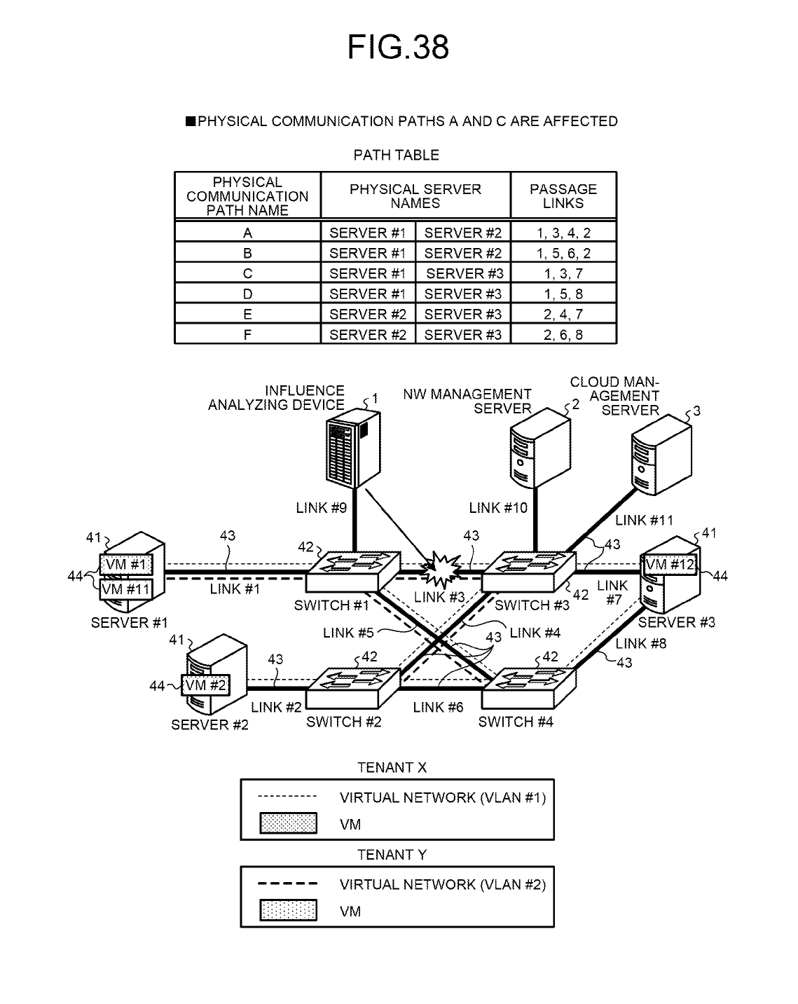

FIG. 38 is an example diagram of extraction of a physical communication path affected when a failure occurs. FIG. 38 illustrates a case where a failure occurs in the link #3. The identifying unit 19 identifies a physical communication path including the link 43 on which the failure occurs using the path table 14. In FIG. 38, the identifying unit 19 identifies the physical communication paths A and C as the physical communication path including the link #3. While the identifying unit 19 identifies the physical communication path including the link 43 on which the failure occurs using the path table 14, the identifying unit 19 may identify the physical communication path including the link 43 on which the failure occurs using the association table 15.

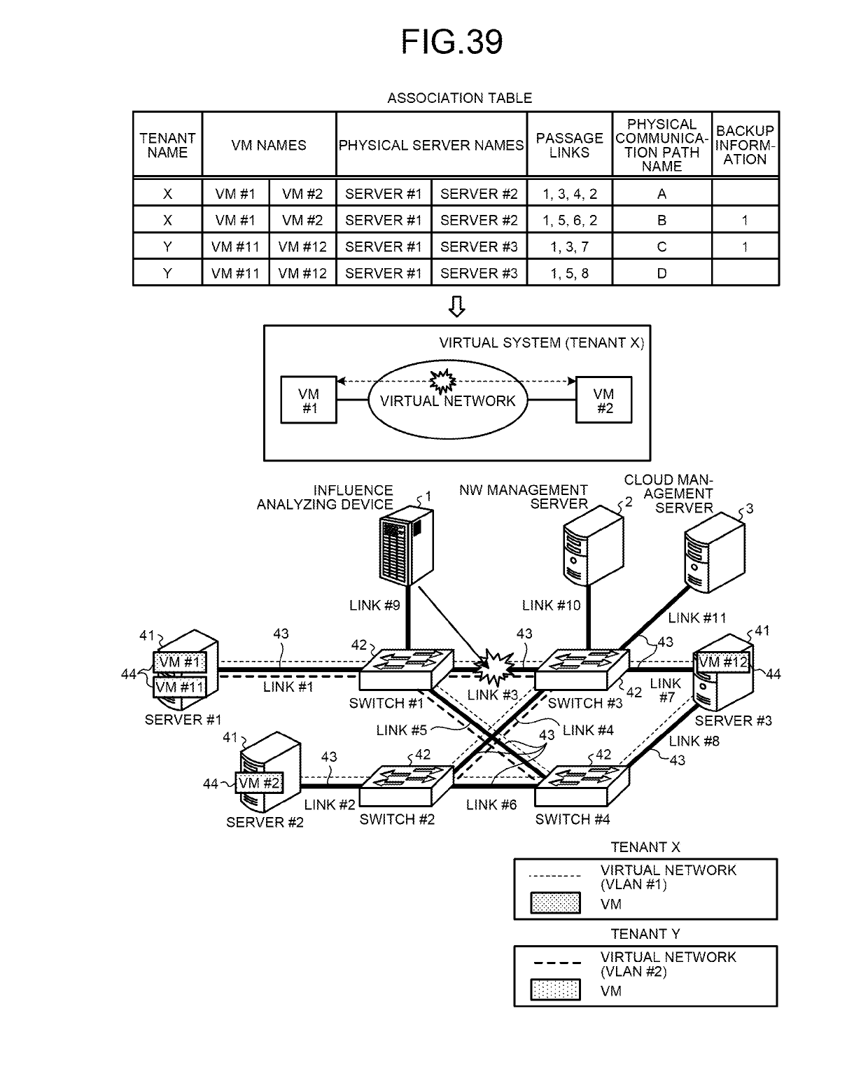

FIG. 39 is an example diagram of identification of an affected range when the failure occurs. The identifying unit 19 identifies communication between VMs corresponding to the identified physical communication paths using the association table 15. Because the physical communication path C in FIG. 39 is a backup path, the communication between the VMs #11 and #12 corresponding to the physical communication path C is not affected. This correspondence allows the identifying unit 19 to identify the communication between the VMs #1 and #2 corresponding to the physical communication path A as the affected communication between VMs.

As described above, the link table 11 according to the embodiment stores therein the information on the links between the devices, the VM table 12 stores therein the information on the VMs 44, and the VNW table 13 stores therein the information on the links on which the virtual network is set. The physical path creating unit 21 creates the path table 14, which is the table of the physical communication paths, using the link table 11. The VM communication extracting unit 22 extracts all the communication between VMs using the VM table 12. The server communication extracting unit 23 extracts communication between servers corresponding to the communication between VMs. The VNW path extracting unit 24 extracts physical communication paths on which the virtual network is set from the path table 14 using the VNW table 13.

The associating unit 26 associates the communication between VMs with the physical communication paths, thereby creating the association table 15. The identifying unit 19 identifies communication between VMs affected by the link 43 on which a failure occurs using the association table 15. This identification allows the influence analyzing device 1 to identify not only the affected tenant but also the affected VMs 44 in a network infrastructure failure.

The physical path creating unit 21 according to the embodiment creates the physical communication paths in a manner preventing any loop from being generated. Thus, the associating unit 26 can associate the physical communication paths including no loop with the communication between VMs.

The backup path extracting unit 25 according to the embodiment extracts a backup path and registers the information indicating that the physical communication path is the backup path in the path table 14. The identifying unit 19 excludes the backup path from the physical communication paths affected by the link 43 on which the failure occurs. Thus, the influence analyzing device 1 can accurately identify the affected VMs 44 in a network infrastructure failure even in a case where a backup path is present.

The association table 15 according to the embodiment includes information on a plurality of tenants. Thus, the influence analyzing device 1 can identify the affected VMs 44 in a network infrastructure failure for a plurality of tenants.

When a VM 44 is added or removed, the VNW path extracting unit 24 according to the embodiment updates the path table 14, and the associating unit 26 updates the association table 15. This updating allows the influence analyzing device 1 to accurately identify the affected VMs 44 in a network infrastructure failure even in a case where a VM 44 is added or removed.

When a server 41 is added or removed, the physical path creating unit 21 according to the embodiment updates the path table 14. This updating allows the influence analyzing device 1 to accurately identify the affected VMs 44 in a network infrastructure failure even in a case where a server 41 is added or removed.

The explanation has been made of the influence analyzing device 1 according to the embodiment. By embodying the configuration of the influence analyzing device 1 as software, it is possible to provide a control program having the same functions as those of the influence analyzing device 1. The following describes a computer that executes the control program.

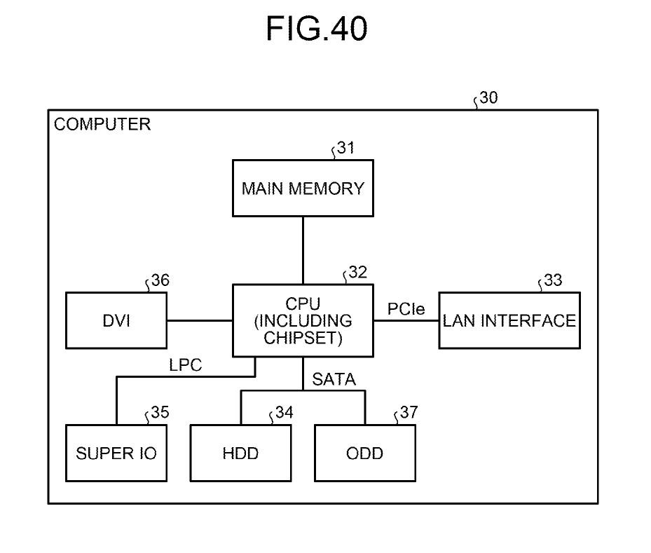

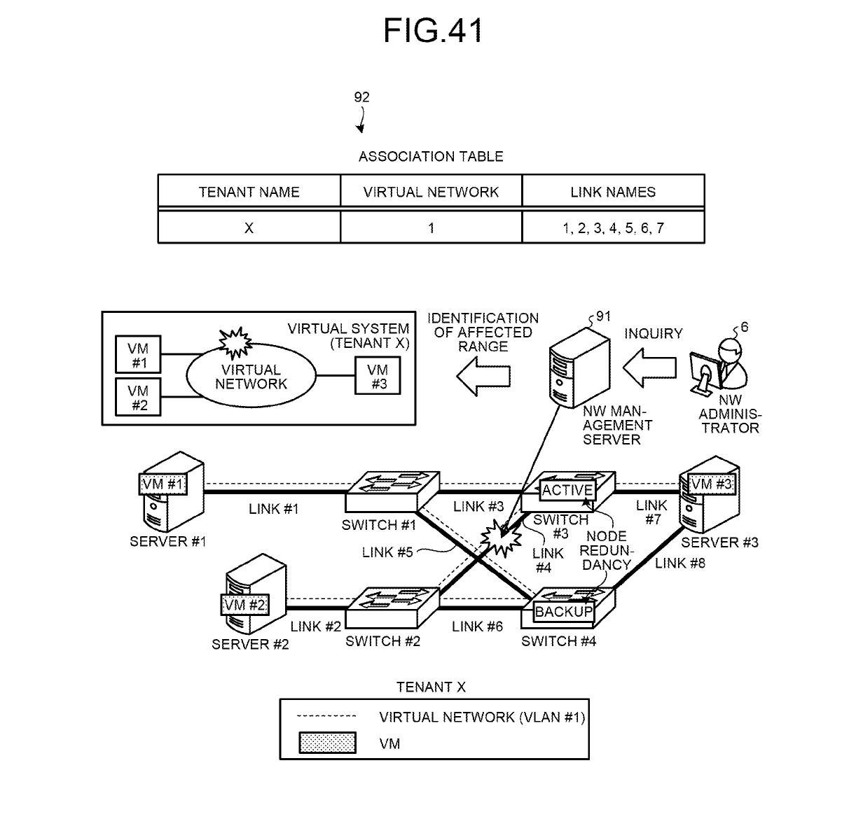

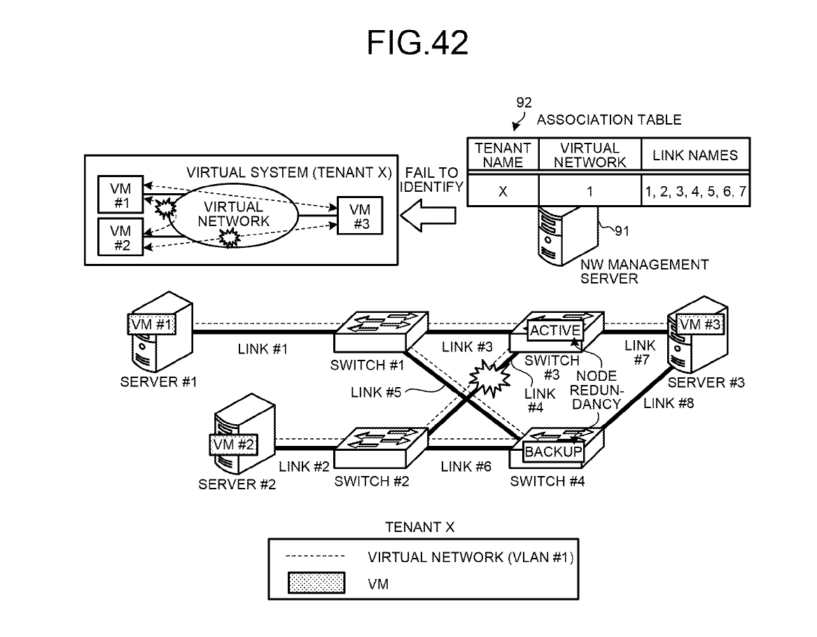

FIG. 40 is a diagram of a hardware configuration of the computer that executes the control program according to the embodiment. As illustrated in FIG. 40, a computer 30 includes a main memory 31, a central processing unit (CPU) 32, a local area network (LAN) interface 33, and a hard disk drive (HDD) 34. The computer 30 further includes a super input/output (IO) 35, a digital visual interface (DVI) 36, and an optical disk drive (ODD) 37.

The main memory 31 stores therein a computer program, a halfway result of execution of the computer program, and the like. The CPU 32 is a central processor that reads and executes a computer program from the main memory 31. The CPU 32 includes a chipset provided with a memory controller.

The LAN interface 33 connects the computer 30 to another computer via a LAN. The HDD 34 is a disk device that stores therein a computer program and data. The super IO 35 connects an input device, such as a mouse and a keyboard, to the computer 30. The DVI 36 connects a liquid-crystal display device to the computer 30. The ODD 37 is a device that reads and writes data from and to a digital versatile disc (DVD).

The LAN interface 33 is connected to the CPU 32 by PCI express (PCIe). The HDD 34 and the ODD 37 are connected to the CPU 32 by serial advanced technology attachment (SATA). The super IO 35 is connected to the CPU 32 by low pin count (LPC).

The control program executed by the computer 30 is stored in a DVD. The control program is read from the DVD and installed in the computer 30 by the ODD 37. Alternatively, the control program is stored in a database of another computer system connected to the computer 30 via the LAN interface 33, for example. The control program is read from the database and installed in the computer 30. The installed control program is stored in the HDD 34, read to the main memory 31, and executed by the CPU 32.

While the association table 15 according to the embodiment includes the information in the path table 14, the present invention is not limited thereto. The present invention is also applicable to a case where the association table 15 does not include information other than the physical communication path name out of the information in the path table 14. In this case, the identifying unit identifies the name of the physical communication path including the link 43 on which a failure occurs using the path table 14. The identifying unit then identifies the communication between servers corresponding to the physical communication path with the identified name using the association table.

While the influence analyzing device 1 according to the embodiment receives the information used to analyze an influence from the NW management server 2 and the cloud management server 3, the present invention is not limited thereto. The present invention is also applicable to a case where the influence analyzing device 1 receives the information used to analyze an influence from another device.

The embodiment can identify VMs affected when a failure occurs in a network.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system comprising:
a switch device;
a plurality of information processing devices connected via the switch device; and
a management device that controls the switch device and the information processing devices, wherein
the management device comprising:
a physical communication path information generating unit that generates physical communication path information served as communication path information between the information processing devices connected via the switch device;
a virtual communication path information extracting unit that extracts virtual communication path information served as communication path information between virtual machines executed by the respective information processing devices;
a path correspondence relation generating unit that extracts the physical communication path information corresponding to the extracted virtual communication path information out of the generated physical communication path information and associates the physical communication path information with the virtual communication path information;
a path association information extracting unit that extracts passage links on which a virtual network is set from link information on the switch device and link information on the information processing devices included in the virtual communication path information and deletes physical communication path information corresponding to a physical communication path passing through a passage link other than the extracted passage links on which the virtual network is set from the physical communication path information extracted by the path correspondence relation generating unit, thereby extracting path association information indicative of a correspondence relation among the virtual communication path information, the physical communication path information, and the passage links on which the virtual network is set; and
a failure identifying unit that identifies the virtual communication path information including a passage link on which a failure occurs on the basis of the extracted path association information.

2. The information processing system according to claim 1, wherein, when generating the physical communication path information, the physical communication path information generating unit generates the physical communication path information including only a communication path that generates no loop.

3. The information processing system according to claim 1, further comprising:
a backup path extracting unit that extracts a backup path passing through a backup switch device, wherein
the path association information extracting unit adds information indicative of being a backup path to the physical communication path information corresponding to the backup path extracted by the backup path extracting unit and extracts the pass association information.

4. The information processing system according to claim 1, wherein
the virtual communication path information extracting unit extracts, when a plurality of tenants are present, the virtual communication path information for each tenant,
the path correspondence relation generating unit extracts, when the tenants are present, the physical communication path information corresponding to the virtual communication path information for each tenant, and
the path association information extracting unit extracts, when the tenants are present, the path association information for each tenant.

5. The information processing system according to claim 1, wherein
the virtual communication path information extracting unit updates, when a virtual machine is added or removed, the virtual communication path information,
the path correspondence relation generating unit extracts the physical communication path information corresponding to the updated virtual communication path information and updates association, and
the path association information extracting unit extracts the path association information on the basis of the updated association.

6. The information processing system according to claim 1, wherein the physical communication path information generating unit updates, when an information processing device is added or removed, the physical communication path information.

7. A method for controlling an information processing system including a switch device, a plurality of information processing devices connected via the switch device, and a management device that controls the switch device and the information processing devices, the method causing the management device to execute a process comprising:
generating physical communication path information served as communication path information between the information processing devices connected via the switch device;
extracting virtual communication path information served as communication path information between virtual machines executed by the respective information processing devices;
extracting the physical communication path information corresponding to the extracted virtual communication path information out of the generated physical communication path information and associating the physical communication path information with the virtual communication path information;
extracting passage links on which a virtual network is set from link information on the switch device and link information on the information processing devices included in the virtual communication path information and deleting physical communication path information corresponding to a physical communication path passing through a passage link other than the extracted passage links on which the virtual network is set from the physical communication path information, thereby extracting path association information indicative of a correspondence relation among the virtual communication path information, the physical communication path information, and the passage links on which the virtual network is set; and
identifying the virtual communication path information including a passage link on which a failure occurs on the basis of the extracted path association information.

8. A non-transitory computer-readable storage medium storing a control program of a management device that controls a switch device and a plurality of information processing devices connected via the switch device, the control program causing a computer included in the management device to execute a process comprising:
generating physical communication path information served as communication path information between the information processing devices connected via the switch device;
extracting virtual communication path information served as communication path information between virtual machines executed by the respective information processing devices;
extracting the physical communication path information corresponding to the extracted virtual communication path information out of the generated physical communication path information and associating the physical communication path information with the virtual communication path information;
extracting passage links on which a virtual network is set from link information on the switch device and link information on the information processing devices included in the virtual communication path information and deleting physical communication path information corresponding to a physical communication path passing through a passage link other than the extracted passage links on which the virtual network is set from the physical communication path information, thereby extracting path association information indicative of a correspondence relation among the virtual communication path information, the physical communication path information, and the passage links on which the virtual network is set; and
identifying the virtual communication path information including a passage link on which a failure occurs on the basis of the extracted path association information.
